(19) United States
(12) Patent Application Publication
(10) Pub. No.: US 2012/0095993 A1
(43) Pub. Date: Apr. 19, 2012

(54) RANKING BY SIMILARITY LEVEL IN MEANING FOR WRITTEN DOCUMENTS

(75) Inventor: Jeng-Jye Shau, Palo Alto, CA (US)

(73) Assignee: Jeng-Jye Shau, Palo Alto, CA (US)

(21) Appl. No.: 12/906,945

(22) Filed: Oct. 18, 2010

(51) Int. Cl. G06F 17/30

(52) U.S. Cl. 707/723; 707/769; 707/E17.014

(57) ABSTRACT

The present invention provides tools to help readers select among large number of written documents by ranking using similarity level in meaning. The ranking tools also can be combined with other ranking methods such as ranking in popularity or ranking by expert opinions. Potential applications include ranking of web pages, electrical mails, academic articles, patent publications, The Bible, or other written documents.

### BACKGROUND OF THE INVENTION

The present invention relates to ranking tools for written documents.

Advances in technologies have brought revolutionary changes in studying written documents. Before the age of electrical mails, a person may save a few precious letters in his/her drawer. Now we can save thousands of electrical mails in data storage systems provided by internet service companies. Before computerization of scientific articles, a scientist needed to dig through hundreds of printed articles in a library to find a few helpful references on a topic. Today, the contents of many books can be stored into one integrated circuit chip. An electrical book that is smaller than the size of a conventional book can store the contents of all books in a conventional library. A computer linked to the internet can access data stored at far away data storage systems. A few key strokes can find numerous references in a few seconds. United State Patent Office provides software programs that can execute keyword searches on millions of patent publications. Dialog Information System provides more than 1.4 billion unique records of business and academic databases accessible via the internet or through delivery to enterprise intranets. LexisNexis provides five billion searchable documents from more than 40 thousand legal, news and business sources. These and other resources make huge number of written documents conveniently available to users.

However, the convenience in accessing large numbers of written documents does not always make studying easier. Too many available choices can itself be a problem. For example, when we have thousands of saved electrical mails, sometimes we have great difficulty to find one of the saved mails we need. For another example, a keyword search of scientific articles can find thousands of articles containing the same keywords. However, the same keyword may have different meanings in different context. To seek through a large number of references finding useful ones can consume a long time and cause confusion. Adding more keywords or using more complex searches can reduce the number of search results, but that may increase the chance to miss critical references. For another example, existing patent search software programs can find hundreds or thousands of potentially relevant references in a keyword search. However, most of the references found by keyword searches are typically found irrelevant after detailed reading. Experienced patent researchers are able to narrow down the number of references with proper selection of keywords arranged in proper query commands. However, there is always a risk in missing a valid reference while narrowing down search results. For patent search, a missed relevant reference can become an expensive mistake. Legal document searches have the same issues. This problem is especially troublesome for renowned books that have a large number of supporting documents. For example, the Bible Gateway website provides more than one hundred versions of Bible translations. A reader can select any one of the available translations to any part of The Bible, and display the selected translation on a computer screen. This database is highly valuable for detailed Bible study. However, it is difficult for a reader to determine which one among more than 100 choices is likely to be the best translation for a particular verse. Bible study software programs such as e-Sword or Bible-Explorer can display multiple translations and commentaries simultaneously on a computer screen. However, displaying more information does not always make it easier to understand the contents. Looking up other supporting documents such as commentaries or references has the same problem. Existing Bible study software programs typically provide keyword search capabilities that can find all verses in The Bible that contain the same keyword(s). However, the same word can have different meanings in different context, while the same meaning may be translated into different words in different context. Keyword searches are helpful, but they are not necessarily adequate. It is therefore highly desirable to develop more effective tools.

Ranking is one of the most effective methods to help readers select from a large number of documents. “Ranking order”, by definition, is a relationship between a set of items such that, for any two items, the first is either ‘ranked higher than’, ‘ranked lower than’ or ‘ranked equal to’ the second. By reducing the results of detailed analysis to comparable measures such as ordinary numbers or sequences, rankings make it possible to evaluate complex information according to certain criteria. Ranking analysis commonly requires statistics. Ranking is typically applied on large number of written documents. Comparisons done on small number (less than 5) of documents maybe useful for applications such as error checking but typically not worth while for ranking. Therefore, by definition, tools that are only used to compare less than 5 documents are not considered as ranking tools.

Ranking of web pages by internet search engines is a common example for applications of ranking methods. An internet keyword search may find millions of web papers while the search engines selectively displays a few web pages with the highest ranking by internet hit rate. Ranking by hit rate for web pages has been proven to be highly successful for helping users to select web pages, but ranking by hit rate does not always provide the best results for every individual case. Ranking by hit rate also is not always applicable for ranking specific types of written documents.

Ranking by counting the number of matched keywords in documents is another successful methods typically supported by database management systems. But ranking by matched keyword is effectively only when keywords are selected properly to work with proper query commands. Many readers may not have the expertise to operate query commands effectively. It is therefore desirable to develop other effective ranking tools.

In this patent application, a “written document” means a document consisting mainly of writing(s), and writing, by definition, is the representation of language in a textual medium through the use of a set of signs or symbols. Example of written documents include books, part(s) of a book, book references, patent publications, academic article(s), stories, writing(s) stored in computer text file(s), web page(s) that comprise(s) writings, electrical mails, or other types of texts with linguish meanings.

A “text file”, by definition, is a computer readable file consisting mainly of printable characterized from a recognized character set that comprises characters on typical computer key boards. The character set can be English characters or characters of other languages. A text file may store characters as symbols without linguish meanings. A text file also can store characters that form words, phrases, or sentences that have linguish meanings. Therefore, a text file can be a written document, but it is not necessarily always a written document. A text file can store the contents of written document(s) word-by-word, it also can use keywords or indexes to represent the contents of written document(s).

A “web page”, by definition, is a document or resource of information that is suitable for the World Wide Web, and can be accessed through a web browser and displayed on a computer screen or mobile device. A web page can comprise the content(s) of written document(s).

In this patent application, a “book” is defined as a set or collection of written document(s) printed on paper, usually fastened together to hinge at one side. A “periodical”, defined in this patent application, is a publication printed on paper that appears in a new edition on a regular schedule. In library and information science, a book is called a monograph, to distinguish it from serial periodicals. Following common understanding, defined in this patent application, a periodical is considered as a kind of book. In other words, books include periodicals, according to the terminology used in this patent application. A computer file may store the contents of a book, but the file itself is not considered as part of a book because the information is not printed on paper. A web page can store or display the contents of a book, but the web page itself is not considered as part of a book for the same reason. An electronic device such as an “electronic book” may store and display the contents of books, but the device itself is not considered as a book according to the above definitions.

A “reference” of a source document, defined in this patent application, is (A) a written document that has or had been published on paper, and (B) (1) a written document listed as background reading or listed as potentially useful to the reader by the author of the source document, or (2) for patents or patent applications, a “reference” also means a patent, a patent application, or a publication that has the potential to confine the scope of a patent or a patent application, or (3) the references of references. Such references are often listed in an article or book in a section marked “References” or listed in footnotes; the list of references should contain complete bibliographic information so the interested reader can find them in a library. A “reference” defined in this patent application must be a written document that has or had been published on paper. The contents of a “reference” can be displayed on a web page or stored in a computer file, but the web pages or the computer file themselves are not qualified as “references” because they are not publications on paper.

A “translation” is defined as a text that is intended to have the equivalent meaning of an original text in another language. Defined in this patent application, “a translation of a book” must be a written document that has or had been published on paper. The contents of a “translation of a book” can be displayed on a web page or stored in a computer file, but the web page or the computer file themselves are not qualified as “translations of a book” because they are not publications on paper. A translation of a book can be a translation of an earlier translation of a book.

A “commentary” is defined as a critical explanation or interpretation of a text. The goal of commentary is to explore the meaning of the text which then leads to discovering its significance or similarity. Commentary may include textual criticism that is an investigation into the history and origins of the text. Commentary may include the study of the historical and cultural backgrounds for the original author, the text, and the original audience. Other analysis includes classification of the type of literary genres present in the text, and an analysis of grammatical and syntactical features in the text itself. In this patent application, a “commentary of a book” is defined as a commentary for part of or all of a book or for part of or all of a translation of a book, and that this “commentary of a book” has or had been published on paper. The contents of a “commentary of a book” can be displayed on a web page or stored in a computer file, but the web page or the computer file themselves are not qualified as “commentaries of a book” because they are not publications on paper.

### SUMMARY OF THE PREFERRED EMBODIMENTS

The primary objective of the preferred embodiments is, therefore, to assist readers to select among numerous written documents. One primary objective of the preferred embodiments is to provide ranking by similarity level in meaning. One objective of the preferred embodiments is to provide ranking by similarity level in meaning for web pages. Another objective of the preferred embodiments is to provide ranking by similarity level in meaning for electrical mails. Another objective of the preferred embodiments is to provide ranking by similarity level in meaning for translations of books. Another objective of the preferred embodiments is to provide ranking by similarity level in meaning for book references, patent references, or patent search results. One objective of the preferred embodiments is to provide ranking by similarity level in meaning in combination with other ranking methods such as ranking by keywords, ranking by popularity, or ranking by expert opinions. One primary objective of the preferred embodiments is to provide updated ranking after initial ranking. Another primary objective of the preferred embodiments is to search web pages using not only keywords but also equivalent-phrases. These and other objectives are assisted by using meaning comparisons for written documents as measures to represent the potential usefulness of various supporting documents.

While the novel features of the invention are set forth with particularly in the appended claims, the invention, both as to organization and content, will be better understood and appreciated, along with other objects and features thereof, from the following detailed description taken in conjunction with the drawings.

### BRIEF DESCRIPTION OF THE DRAWINGS

FIG. 1(a) shows exemplary flow chart for ranking by keyword matches;

FIGS. 1(b, c) show exemplary flow charts for ranking by similarity level in meaning;

FIG. 1(d) shows a block diagram for an exemplary system that supports ranking by similarity level in meaning;

FIG. 1(e) is an exemplary symbolic diagram for parts of an equivalent-phrase lookup-table;

FIGS. 2(a-h) show exemplary application of ranking tools for web pages;

FIGS. 3(a-g) show exemplary application of ranking tools for patent references;

FIGS. 4(a-e) show exemplary applications of ranking tools for electrical mails;

FIGS. 5(a-k) show exemplary applications of ranking tools for bible translations; and

FIGS. 6(a-b) are exemplary flow charts for reference searches.

### DETAILED DESCRIPTION OF THE PREFERRED EMBODIMENTS

Many algorithms have been developed to rank written documents by text comparisons. One method is to rank written documents using matching levels determined by word-by-word comparison without considering the meanings of the contents. When two written documents are identical word-by-word, the matching level between the two documents are highest; two written documents with more common words typically have higher matching level than two written documents with fewer common words; and when two written documents are completely different, the matching level between the two documents is low. The terminology “matching level” is sometimes called by other names such as “relevance level”. Matching level determined by word-by-word comparison can also be normalized according to the length of the texts. For example, five matches between one page documents are more meaningful than five matches between fifty page documents. Sometimes, parts of the written documents maybe considered more important than other parts of the written documents in word-by-word comparisons for ranking.

Another method is to rank written documents by measuring the matching level using keyword comparison without considering the meanings of the contents. Keywords, by definition, are selected words, phrases, or query commands that are used in text comparisons. Sometimes keywords can include special symbols such as wild cards or query commands to allow more flexibility in text comparison. Keywords are typically selected by user inputs. Keywords also can be selected by software automatically. After keyword selection, a software program analyzes the contents of a written document looking for matched keyword(s); finding matched keyword(s) in a document typically increases the matching level of the document. Keyword comparisons sometimes allow partial matching instead of perfect matching of keywords. Different keywords may have different contributions to the measurement of matching levels; one keyword may be considered more important than the other keyword. It is also possible to have negative keyword(s). Finding matched negative keyword(s) in a written document decreases the matching level of the document. Matching level can also be normalized according to the length of the written documents. Sometimes, parts of the written documents maybe considered more important than other parts of the documents in determining matching level by finding matching keywords.

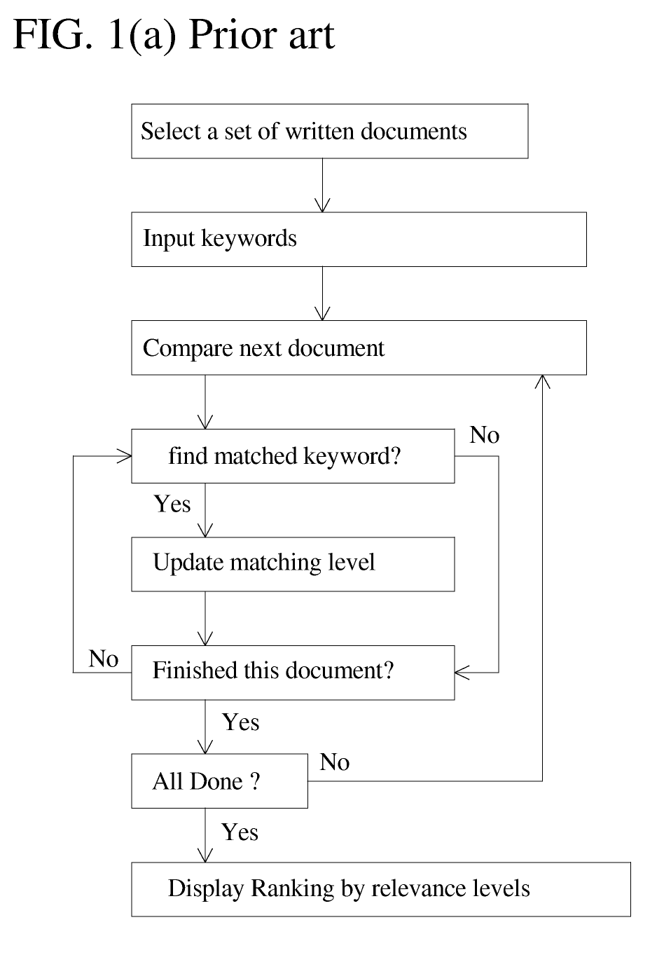

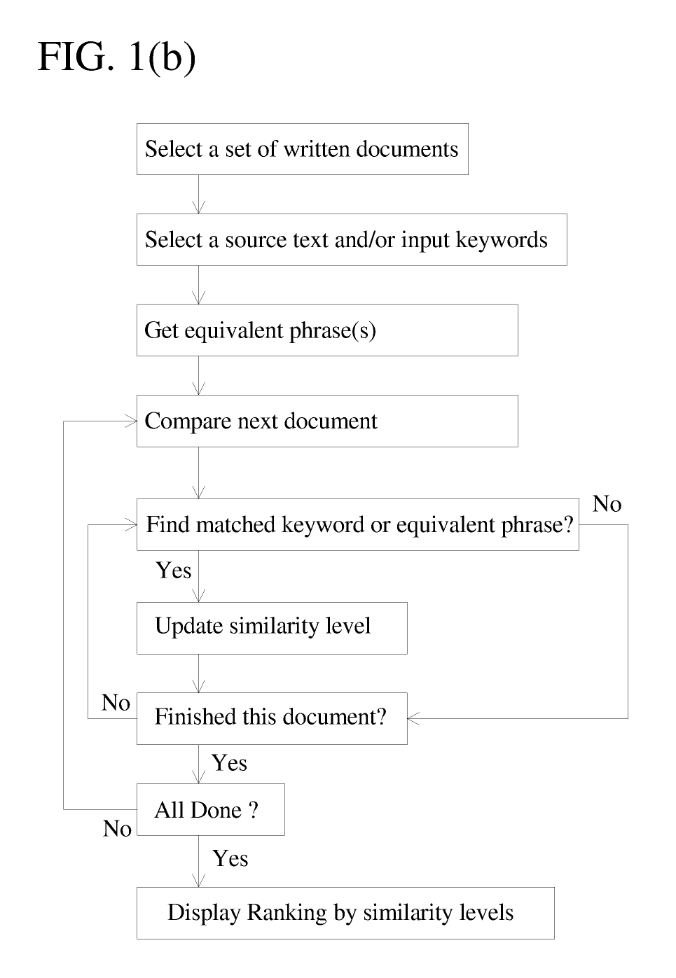

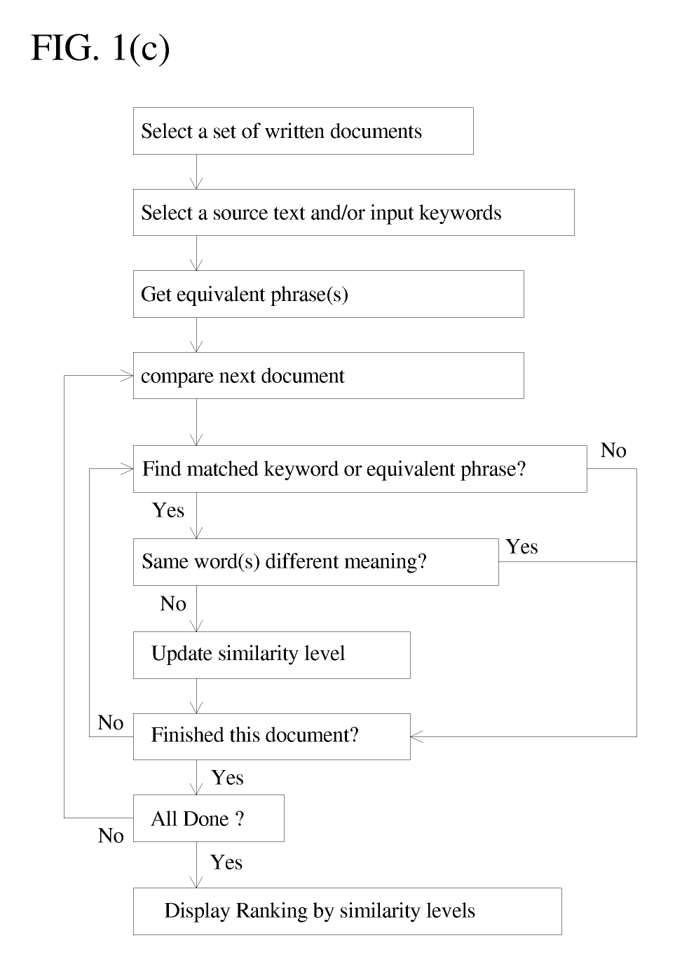

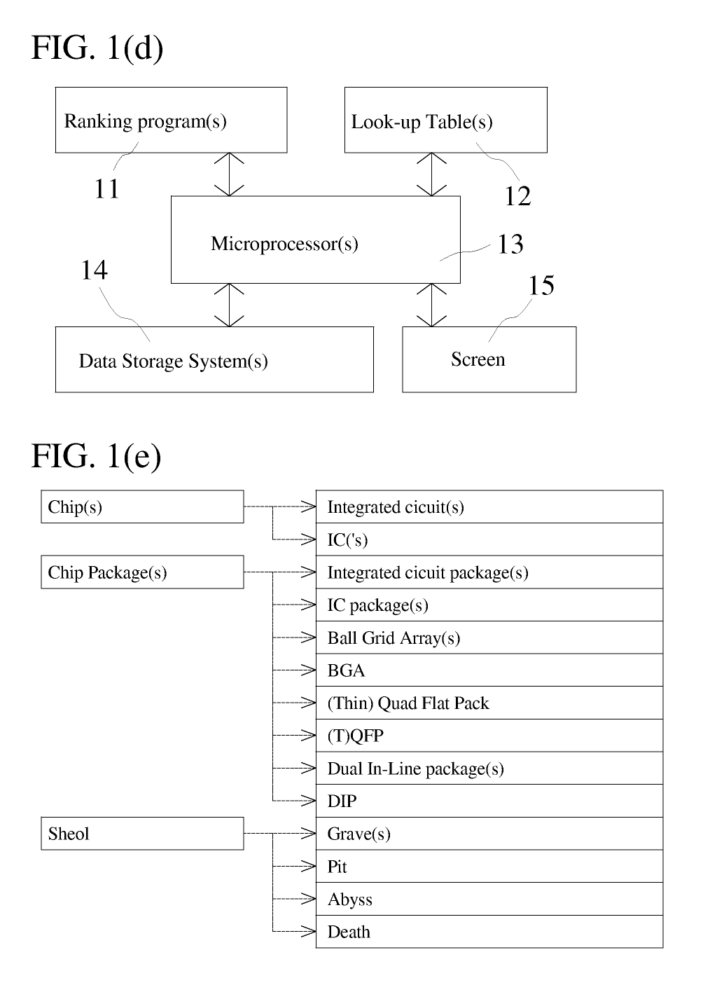

FIG. 1(a) shows an exemplary flow chart for keyword comparison. Typically, the user starts by selecting a set of written documents for comparison. The user may select different priority levels for different parts of the selected written documents. Then the user may input keyword(s), and start text comparisons by scanning through each written document looking for matched keyword(s). Sometime, text comparisons can be done relative to the contents of one or more written document(s) called “source document(s)”. If a keyword match is found in a written document, the software program would update the matching level of the written document. The influence of each keyword match may depend on the type and location of the matched keyword. Such keyword comparisons are repeated until all of the selected written documents are compared, and a matching level is assigned to each written document as part of or all of the criteria for ranking the selected written documents. Such keyword comparison methods use text comparisons without considering other words or phrases that may have similar meanings as the selected keyword(s).

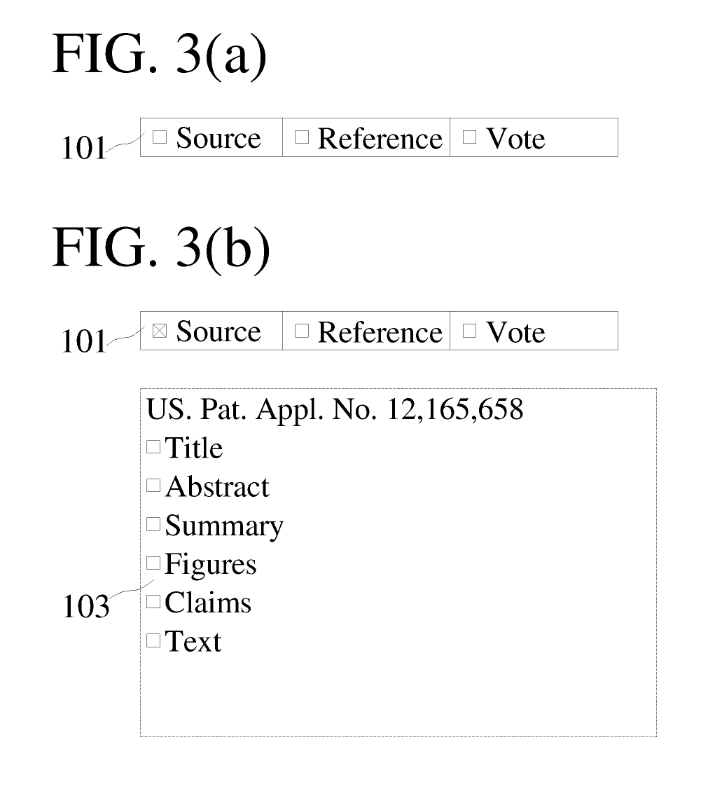

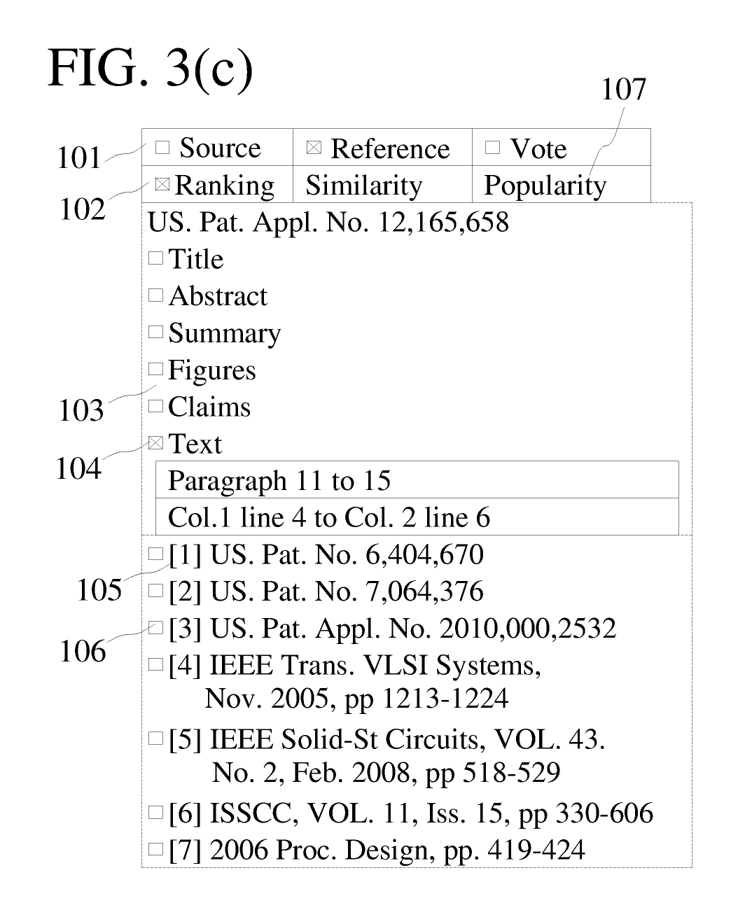

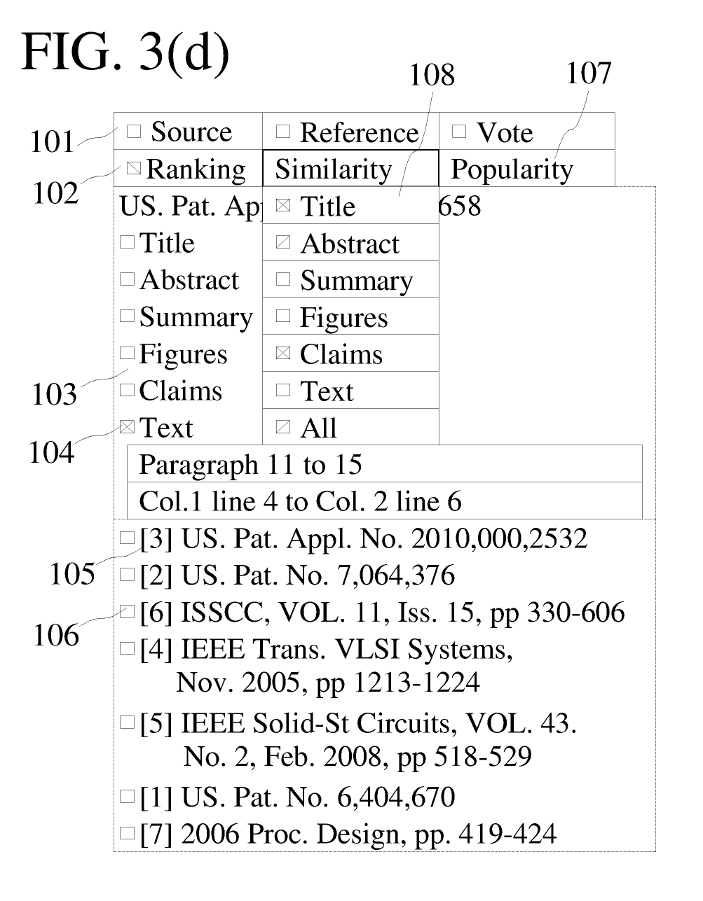

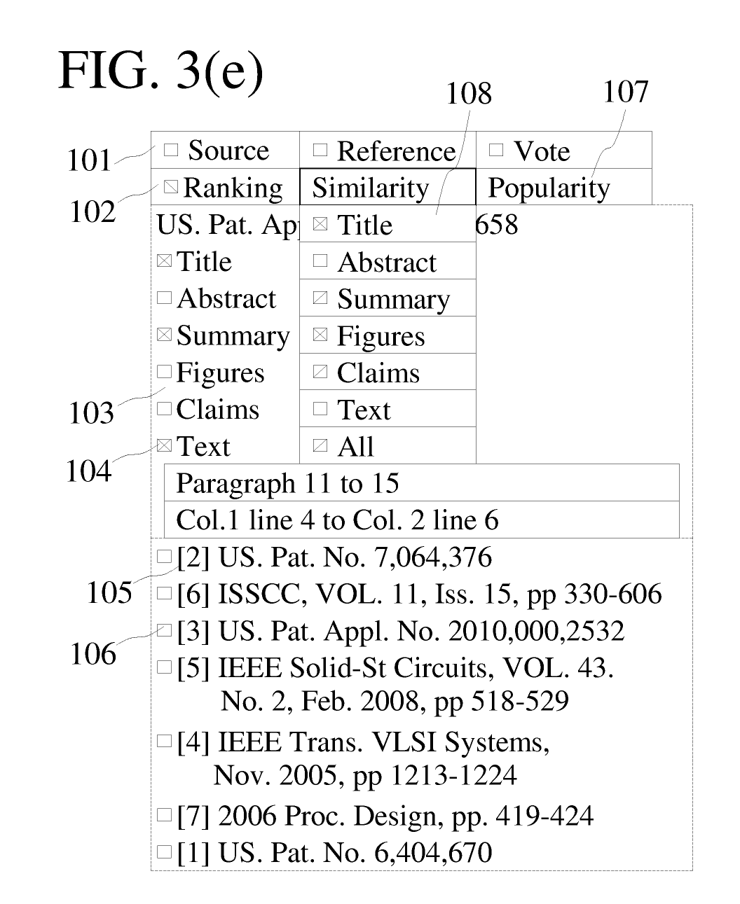

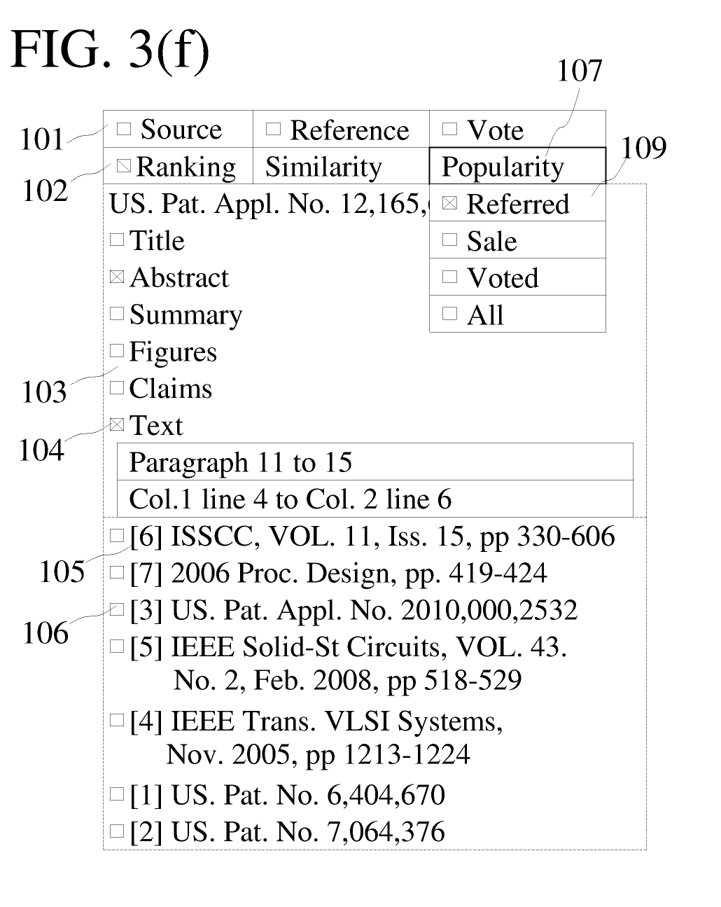

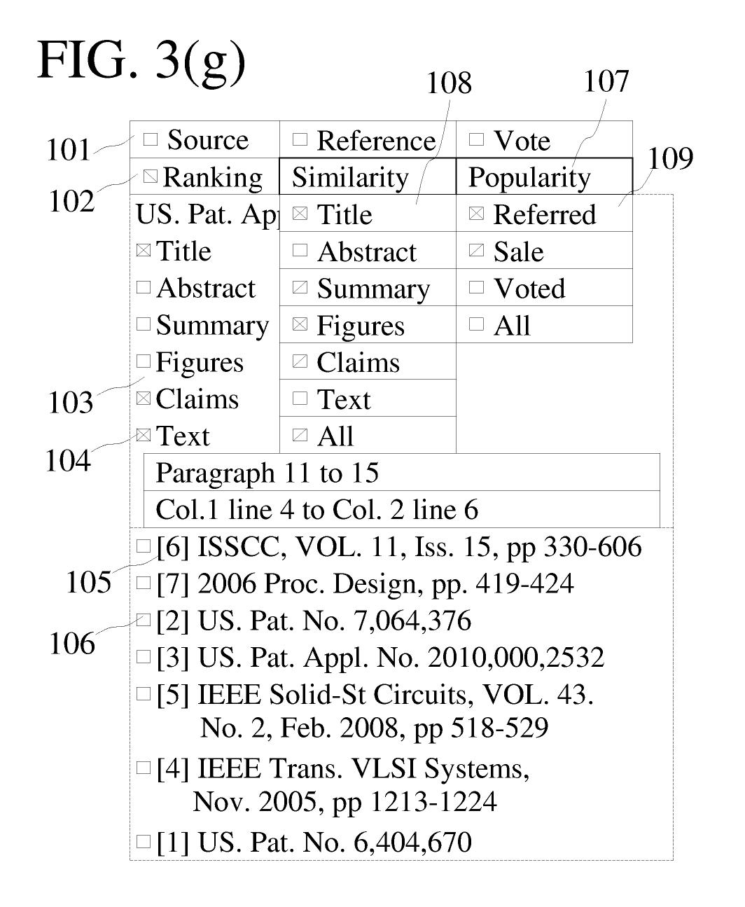

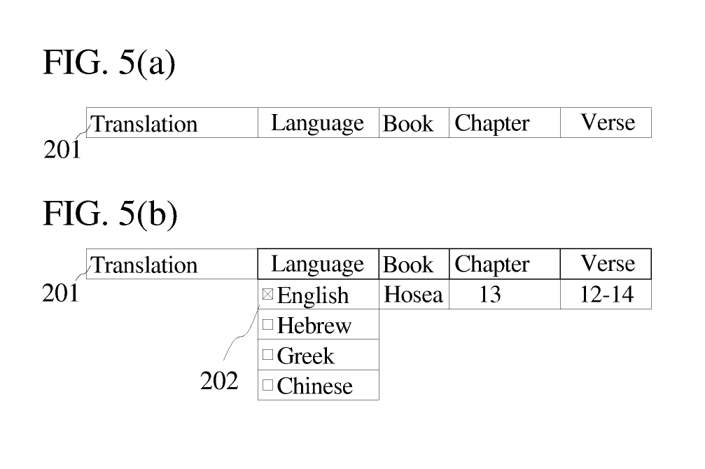

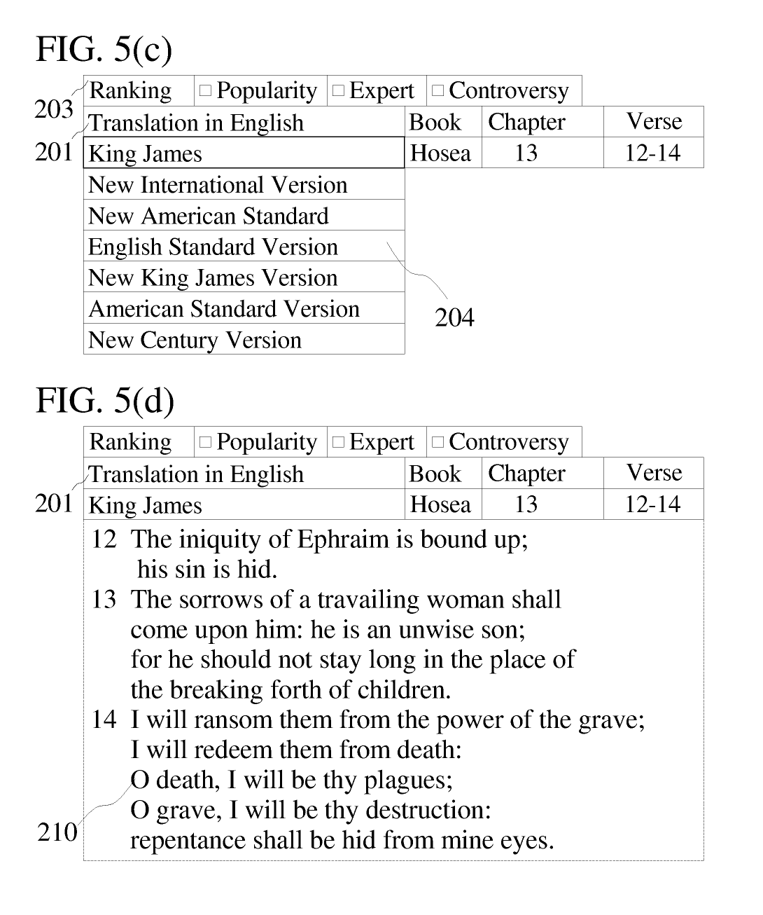

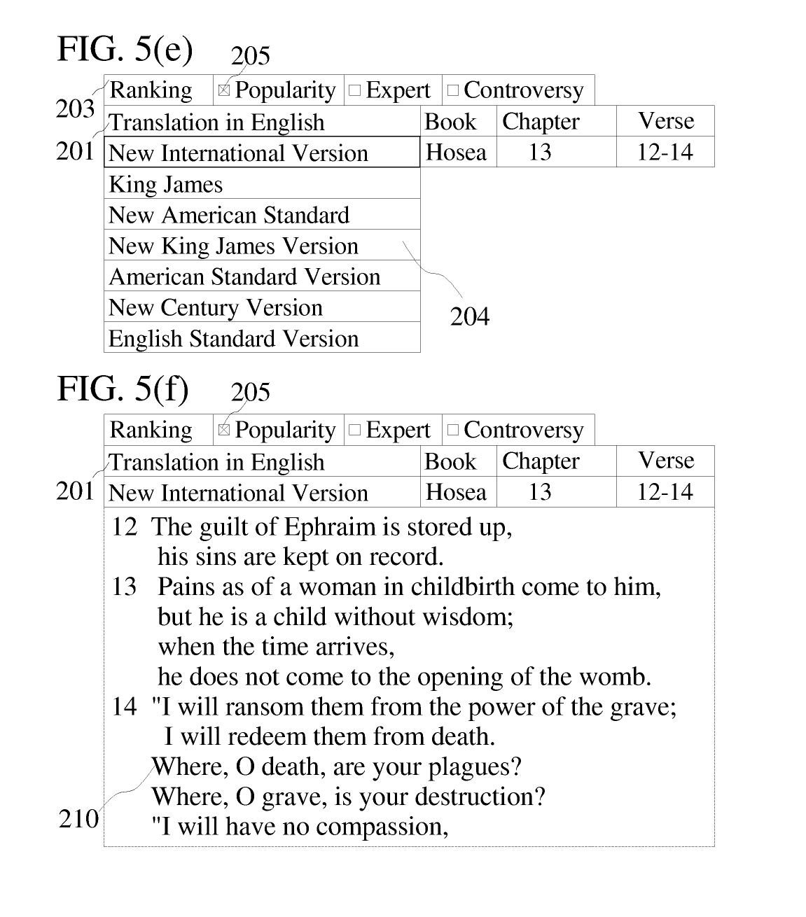

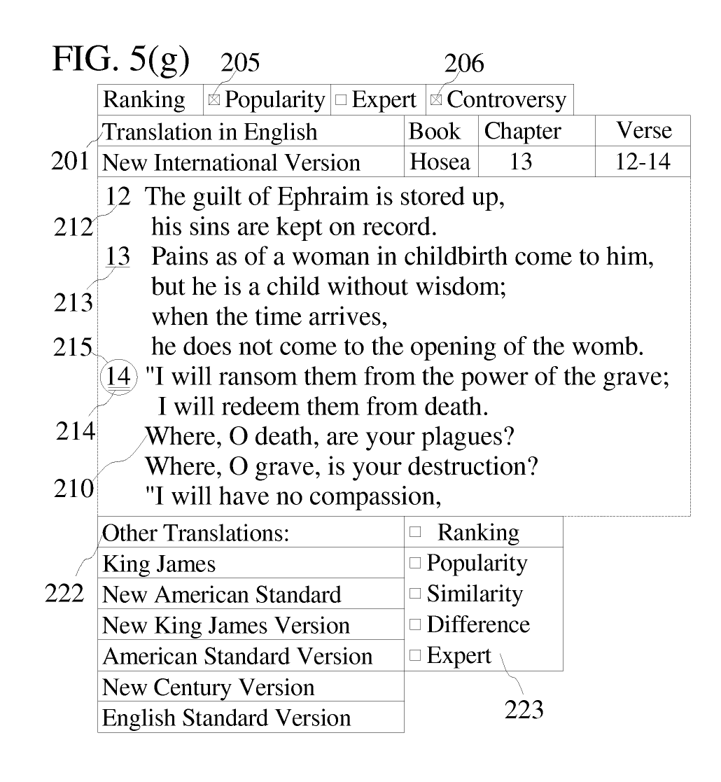

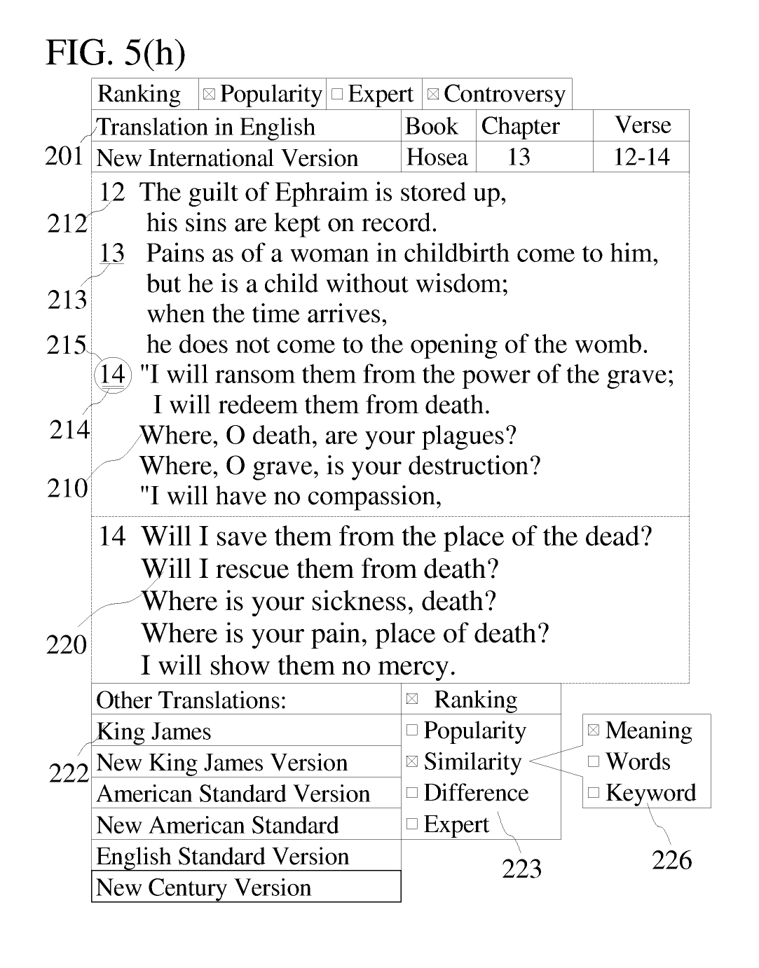

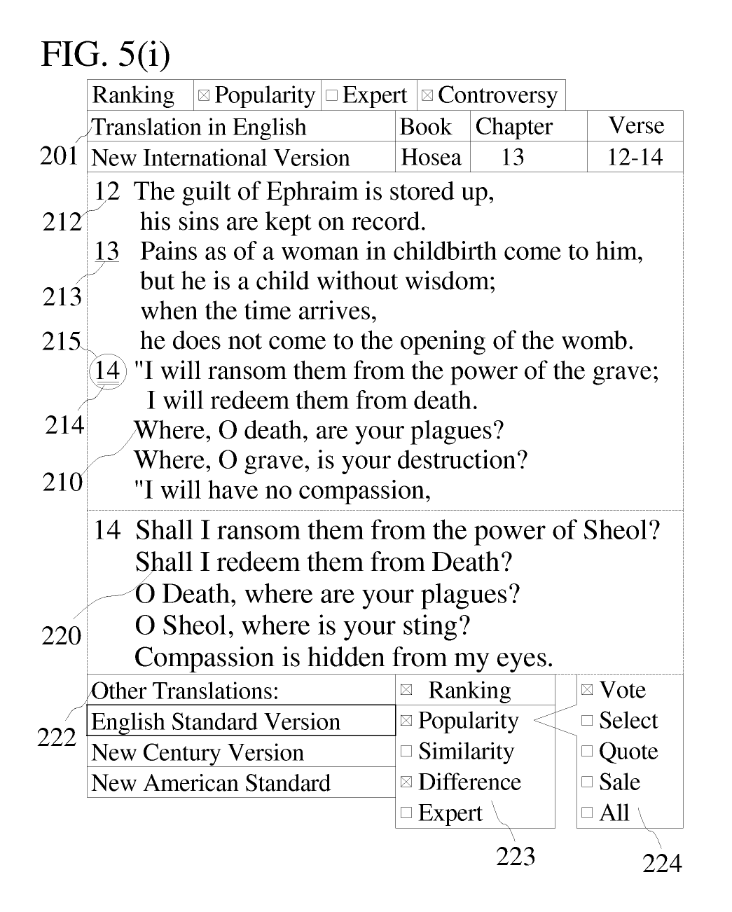

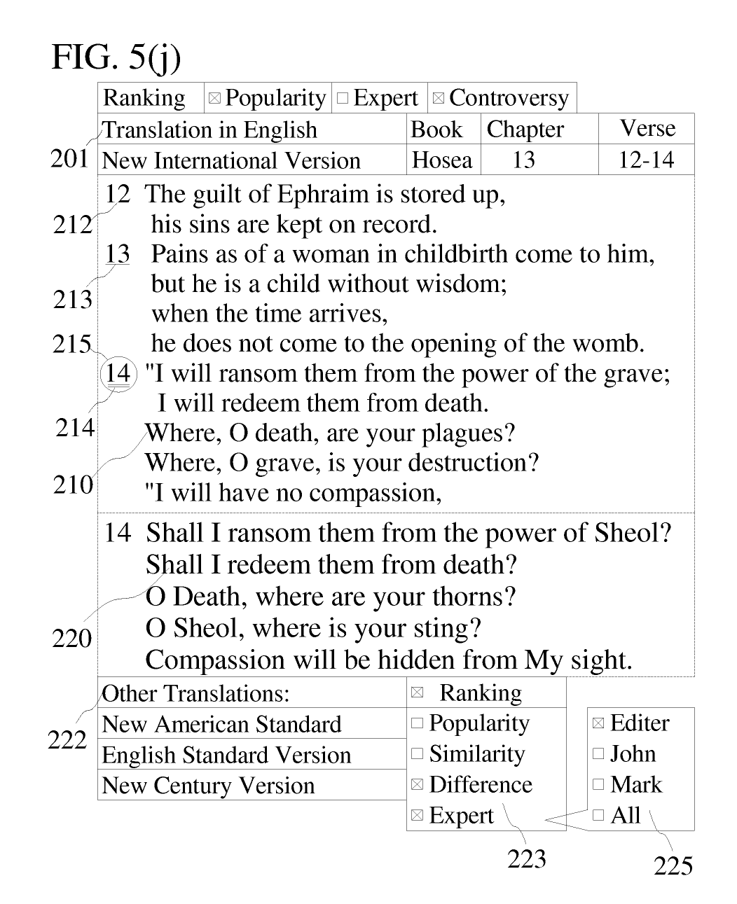

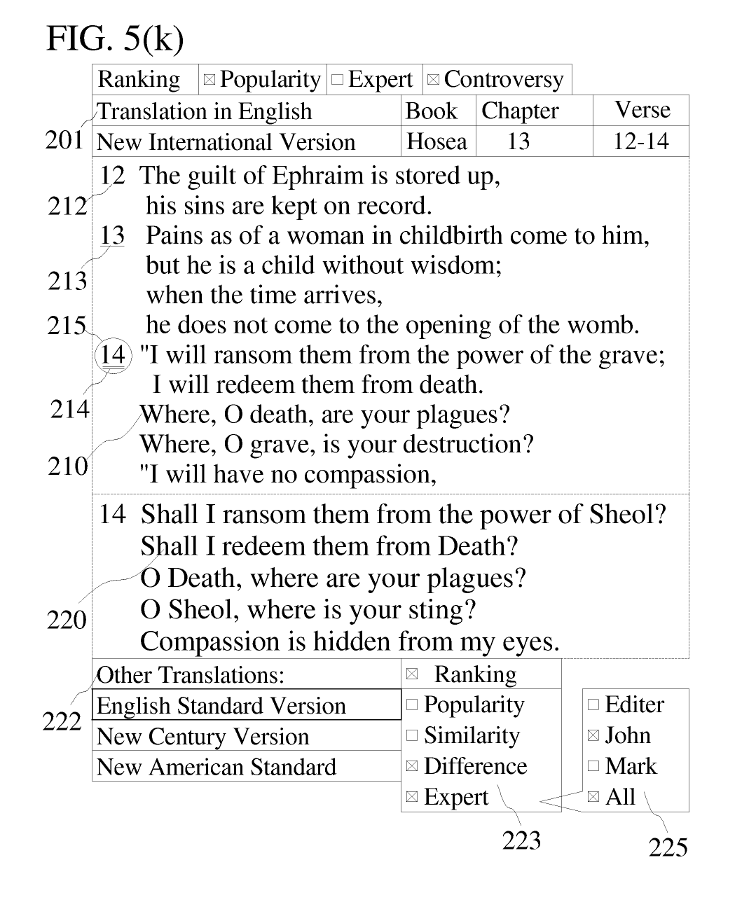

Ranking by similarity in meaning is related to measurement of the “similarity level in meaning” of written documents based on comparison in the meanings of the contents of written documents. Words, phrases, sentences, or texts may be different in words while agree in meanings. Words and phrases may also be identical in words, while disagreeing in meaning. For example, depending on the context, the word “cool” could have completely different meanings. Punctuations also can be important for measuring similarity level in meaning. For example, a sentence ends with a question mark may have opposite meaning with another sentence that has similar words but end with a period, as illustrated by the examples in FIGS. 5(a-k). The similarity level in meaning between two texts with more agreements in meanings is typically higher than the similarity level in meaning between two texts with fewer agreements in meanings. Similarity level in meaning can also be normalized according to the length of the texts. Sometimes, parts of the texts may be considered more important than other parts of the texts in determining similarity level in meaning. For example, a user may consider the title of a document more important than common text in determining similarity. Another user may consider figure captions and summaries more important. It is desirable to allow flexibility in assigning different priorities to various sections of written documents for calculations of similarity levels, as illustrated by the examples shown in FIGS. 3(a-g). Similarity levels in meaning can be calculated by comparing a set of written documents with a set of keyword(s) and/or equivalent-phrases. Similarity levels in meaning also can be calculated by comparing a set of written documents with the contents of one or more written documents, which are called “source documents” in this patent application.

FIG. 1(b) shows an exemplary flow chart for ranking by similarity level in meaning. Typically, the user starts by selecting a set of written documents from a large number of written documents stored in data storage system(s); the number of the selected documents should be more than 4; comparisons done for less than 5 documents maybe useful for applications such as error checking but typically not worth while for ranking. The user may select different priority levels for different parts of the selected written documents. Then the user may select source document(s) and/or keyword(s) to compare with. After the source document(s) and/or keyword(s) are selected, the program automatically looks up “equivalent-phrase lookup-table(s)” to collect a list of equivalent-phrase(s) related to the selected source document(s) and/or keywords. An “equivalent-phrase”, by definition, is a word, words, phrase, phrases, sentence, or sentences that have the same or similar meaning with selected keyword(s) or text. A “lookup-table”, by definition, is an electrically readable data structure that is structured to be efficient in supporting lookup operations. Lookup-tables are typically stored in data storage devices such as hard disks, compact disks, tapes, or integrated circuit memory devices. An “equivalent-phrase lookup-table”, by definition, is a lookup-table that is structured to associate source texts with equivalent-phrases. While receiving a source text, an equivalent-phrase lookup-table returns equivalent phrase(s) related to the source text. The function of an equivalent-phrase lookup-table is therefore similar to an electrically readable dictionary. The contents of equivalent-phrase lookup-tables maybe different for different applications. FIG. 1(e) is an exemplary symbolic diagram showing parts of an equivalent-phrase lookup-table. In this example, keyword “chip” is associated with equivalent-phrases “integrated circuit(s)” or “IC('s)”. A source text also can be a phrase. For example, when a user types in keywords “chip package”, a program equipped with the lookup-table in FIG. 1(e) will be able to understand that a written document containing phrases such as “integrated circuit package(s)”, “IC package(s)”, “Ball Grid Array(s)”, “BGA”, “(Thin) Quad Flat Pack”, “(T)QFP”, “Dual In-Line package(s)”, or “DIP” may have similarity in meaning with the phrase “chip package”. FIG. 1(e) also shows that the word “Sheol” is similar in meaning with “grave(s)”, “pit”, “abyss”, and “death”. The example shown in FIG. 1(e) is simplified for clarity. The symbolic lookup table in FIG. 1(e) only shows equivalent-phrases of three source texts, while typical equivalent-phrase lookup-tables support large number of source texts. Different equivalent-phrase lookup-tables maybe used to support different fields of applications. For example, an equivalent-phrase lookup-table used for bible study and an equivalent-phrase lookup-table used for patent references may return different equivalent phrases for the same source text.

Going back to FIG. 1(b), after looking up for equivalent-phrases, text comparisons are started by scanning through the contents of selected written documents looking for not only matching keywords but also matching equivalent-phrases. If a matched keyword or equivalent-phrase is found, the software program would update the similarity level of the written document. The influence of each matched keyword or equivalent-phrase may depend on the type and the location of the matched keyword or equivalent-phrase. A similarity level in meaning is assigned to each one of the selected written document according to the text comparison results in both keywords and equivalent-phrases. Such comparisons are repeated until all selected written documents are compared, and the similarity levels assigned to selected written documents are used as part of or all of the criteria for ranking the selected written documents, as shown in FIG. 1(b).

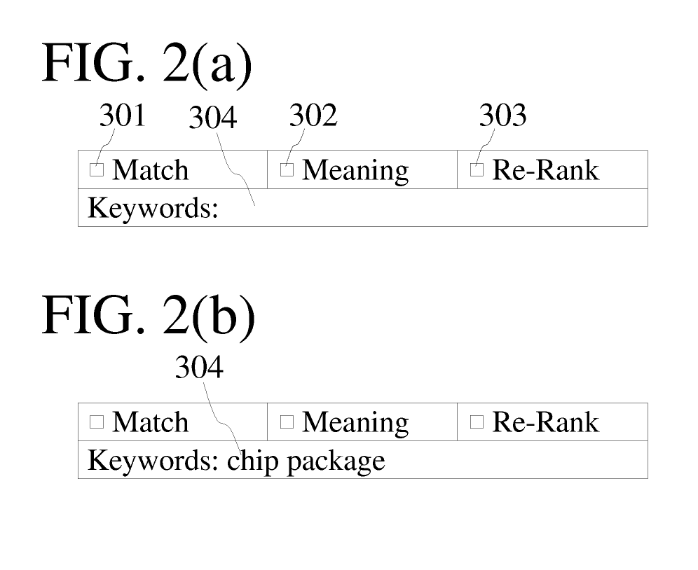

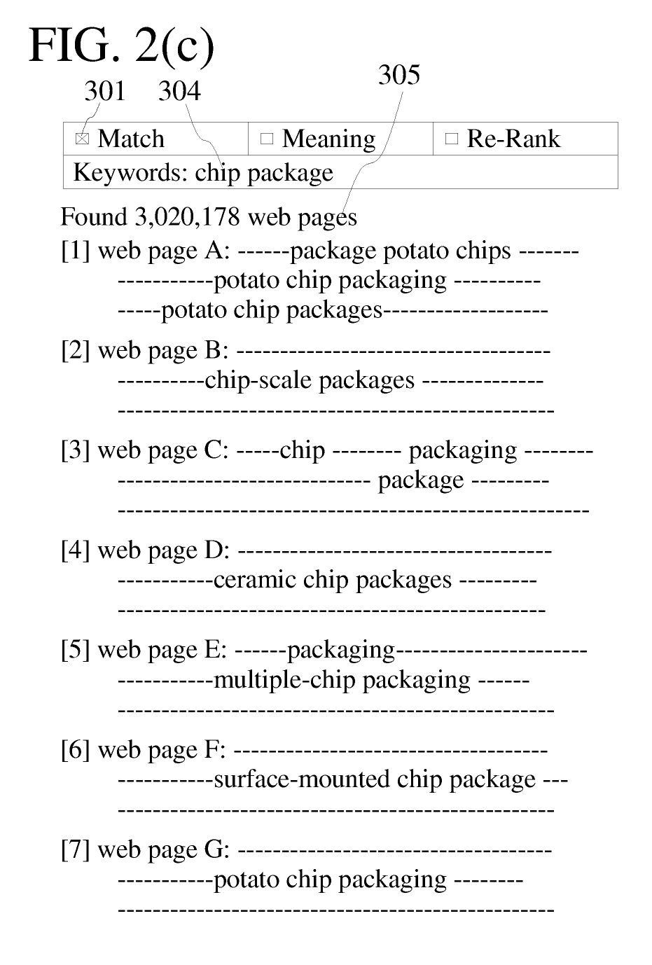

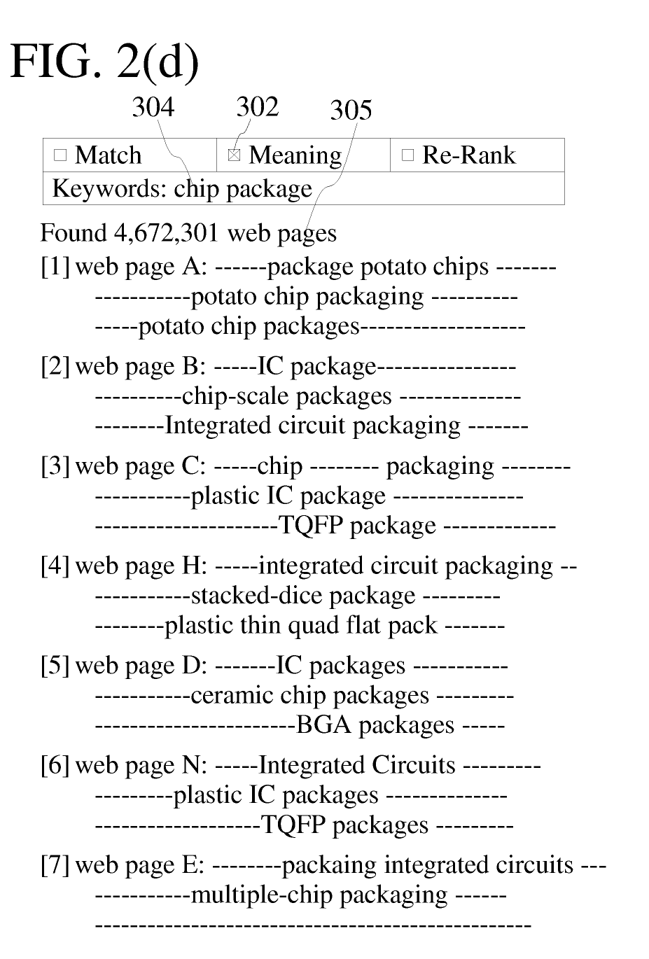

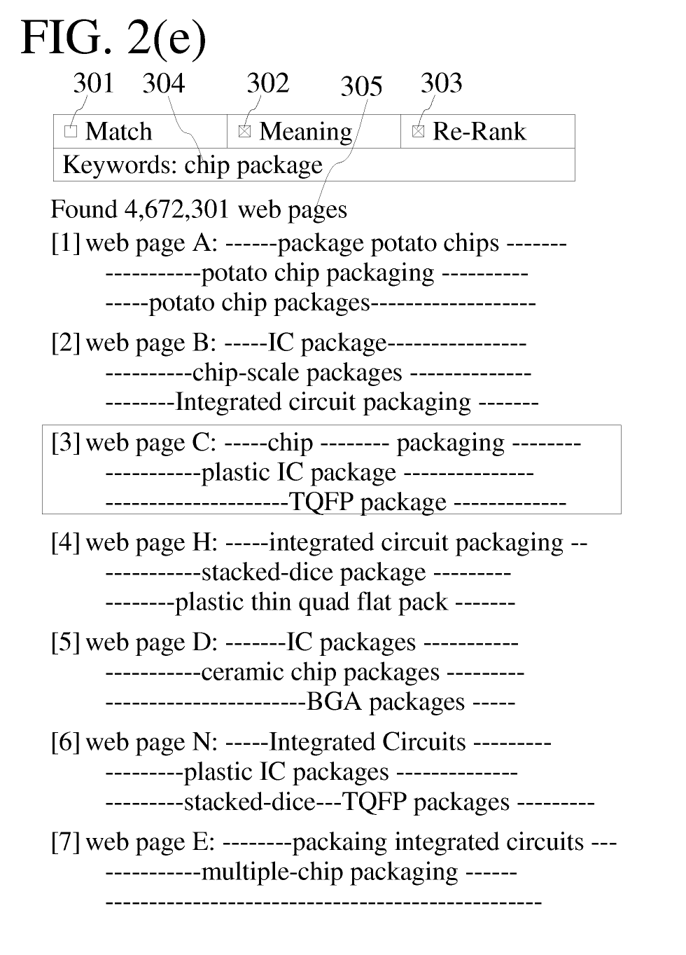

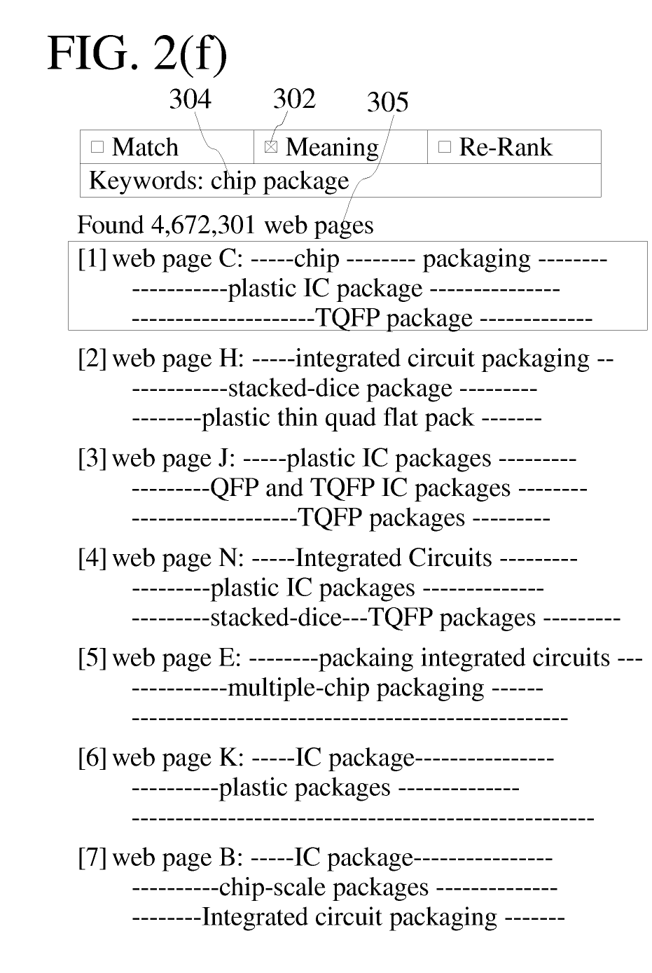

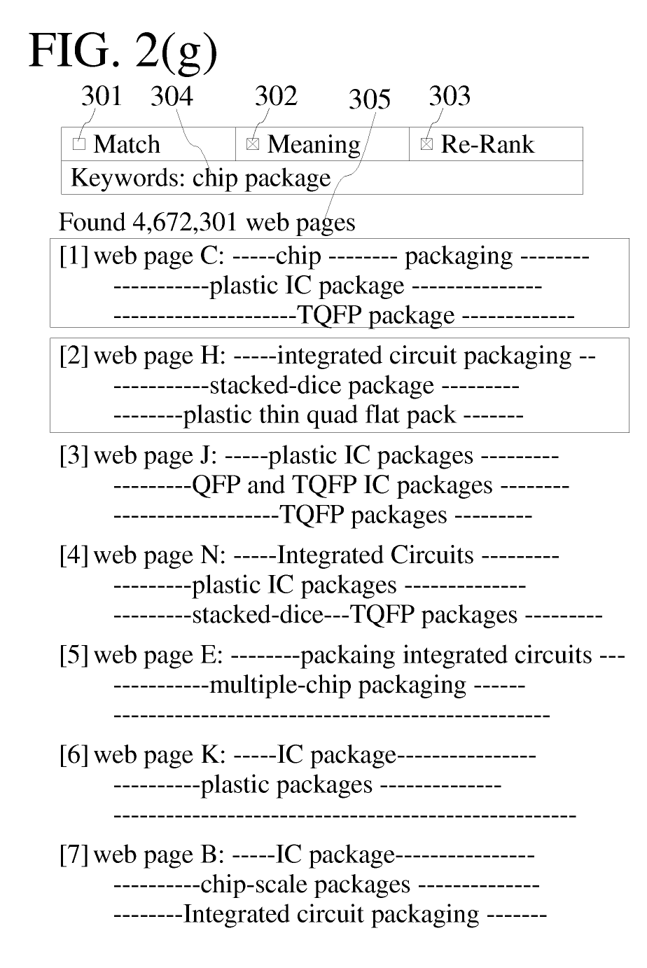

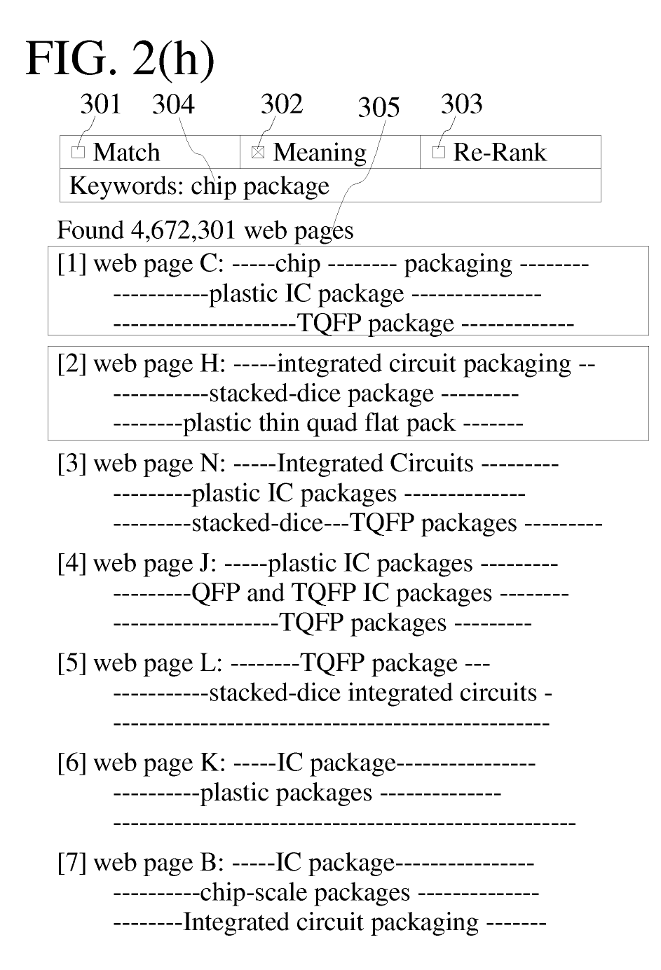

Comparing the flow charts in FIGS. 1(a, b), the major difference between conventional keyword matching and “ranking by similarity level in meaning” is the use of equivalent-phrases. “Ranking by similarity level in meaning” searches not only for matching keywords or source document but also for their equivalent-phrases, so that the ranking results are typically more accurate then conventional keyword matching. Typical keyword matching methods are smart enough to search for partially matched words as illustrated by the examples shown in FIG. 2(c). For example, the user select keyword “chip”, and the program automatically include words such as “chips”, “chip-scale”, or “multiple-chip”. For another example, the user select keyword “package”, and the program automatically include words such as “packages”, “packaging” as matching words. Such methods in searching for words with partially matched spellings are not considered within the scope of searching for equivalent-phrases; they still belong to conventional keyword searches. Words of partially matched spelling are not necessarily equivalent-phrases. Equivalent-phrases can have different spelling as source texts.

Sometimes, the same equivalent-phrase may have different meanings in different contexts. FIG. 1(c) shows a flow chart for another procedure of ranking by similarity level in meaning that has additional capabilities in distinguishing meanings in different contexts. Most of the steps in FIG. 1(c) are the same as the steps in FIG. 1(b). The major difference is that after finding matched keyword, text, or equivalent-phrase, the ranking program would check the contexts around the matched keyword, text or equivalent-phrase to determine whether the matches are indeed found within a context that supports the right meanings. The method shown in FIG. 1(c) is more accurate then the method shown in FIG. 1(b), but it typically requires additional computation resources.

A system that supports ranking by similarity level in meaning typically comprise data storage system(s) (14), ranking program(s) (11), microprocessor(s) (13), equivalent-phrase lookup-table(s) (12), and display devices such as a screen, as shown by the exemplary block diagram in FIG. 1(d). The written documents to be ranked are typically stored in data storage system(s) (14). Examples of data storage systems include integrated circuit memory devices, hard disks, tapes, compact disks, combination of different data storage devices, and so on. A data storage system can be a single device, and it also can be a complex networked system. Ranking program(s) (11) typically are used to control one or more microprocessors (13) to execute tasks such as text comparisons, logic operations, calculations, data movements, and input/output operations. For ranking by similarity level in meanings, one or more equivalent-phrase lookup-table(s) (12) are used to support lookups of equivalent-phrases. The equivalent-phrase lookup-table(s) (12) are typically stored in data storage system(s), but they also can be specialized hardware devices designed to achieve high performance lookup operations. The ranking results are typically displayed on electrical devices such as screen(s) (15).

As illustrated by FIGS. 1(b, c), “ranking by similarity level in meaning” may be implemented in various degrees of sophistication. However, “ranking by similarity level in meaning” always comprises the step of looking up for equivalent-phrases. “Ranking by similarity level in meaning” also may be called by other names, such as “ranking by difference”, “ranking by relevance in meaning”, “ranking by controversy”, or in other names. For example, “ranking by difference” is a kind of “ranking by similarity in meaning” that ranking results are reported in a way that documents with less similarity in meaning is ranked higher than documents with more similarity. FIGS. 5(a-k) show examples when the user wants to find written documents that are different from a source document.

Ranking by popularity, by definition, is a method of ranking a set of selected written documents according to their degree of popularity. The degree of popularity can be measured in many ways. One of the most common examples is to measure the degree of popularity according to internet hit rates as commonly applied by internet search engines. Ranking by references, ranking by sales, ranking by quotation, and ranking by votes are other examples of ranking by popularity. Ranking by reference is a subset of ranking by popularity that measures the degree of popularity of a written document based on the number of publications that listed the written document as a reference. Sometimes it is desirable to assign different weighing factors for different reference sources. For example, a written document referred to by a famous article can be considered more popular than a written document referred by a less known article. Ranking by sales is a subset of ranking by popularity that measures the degree of popularity of a written document based on the number of copies of the written document that have been purchased. Ranking by quotation is a subset of ranking by popularity that measures the degree of popularity of a written document based on the number of quotations by other written documents. It is typically desirable to assign different weighing factors for different quotation sources. Ranking by voting is a subset of ranking by popularity that measures the degree of popularity of a written document based on the number of votes a group of users have voted for the written document. It maybe desirable to assign different weights for the votes of different voters. A subset of ranking by popularity methods also can be a subset of ranking by similarity that measures the degree of popularity of a written document based on the similarity levels of the written document compared to a set of selected written documents. Various software programs may choose to define popularity in different ways. FIGS. 2(a-h), FIGS. 3(a-g) and FIGS. 5(a-k) include examples of ranking by popularity.

Ranking by expert opinion, by definition, is a method of ranking a set of selected written documents according to the opinion(s) of expert(s). It maybe desirable to assign different weights for the opinions of different experts. FIGS. 5(a-k) show examples of ranking by expert opinion.

FIGS. 2(a-h) show exemplary applications of ranking by similarity level in meaning for web pages. FIG. 2(a) shows selection boxes displayed on screen when a user starts the application program in this example. The selection boxes provide three options (301-303): a “Match” option (301) that allows the user to search using conventional keyword match methods, a “Meaning” option (302) that allows the user to search for web pages with matching keywords as well as matching equivalent-phrases of keywords, and a “Re-Rank” option (303) that allows the users to update ranking results after initial ranking. A keyword input box (304) that allows the user to type in keywords is displayed below the three options (301-303). In this example, the user types in keywords “chip package” in the keyword input box (304) as shown in FIG. 2(b). To start a conventional keyword search, the user clicks “Match” option (301), and web pages with contents containing “chip package” are selectively display on screen as shown in FIG. 2(c). Typically, the number of web pages with matching keywords (305) would be displayed. In the example shown in FIG. 2(c), 3020178 web pages were found to have matching keywords. To help the user select from more than three millions of documents, typically those matched web pages are ranked by internet hit rates, and only web pages with highest ranking in hit rate would be listed on screen. Typically, search programs also display a few lines of the contents with matched keywords in each listed web page to help the user to select and view web pages. For simplicity, in the following examples, ‘-’ symbol is used to represent texts that do not contain matched keywords or equivalent-phrases. Instead of showing actual web address, for simplicity, in the following figures web addresses are represented by simplified words such as “web page A”, “web page B”, “web page C”, and so on. For the example shown in FIG. 2(c), “web page A” is selected because it contains “package potato chips”, “potato chip packaging”, “potato chip packages”, and it is listed on top because it has the highest internet hit rate among all web pages with matched keywords. “Web page B” is listed because it contains “chip-scale packages”, and it has the second highest hit rate. “Web page C” is listed because it contains “chip”, “packaging”, “package”, and it has the third highest hit rate. “Web page D” is listed because it contains “ceramic chip packages”, and it has the forth highest hit rate. “Web page E” is listed because it contains “packaging”, “multiple-chip packaging”, and it has the fifth highest hit rate. “Web page F” is listed because it contains “surface-mounted chip package”, and it has the sixth highest hit rate. “Web page G” is listed because it contains “potato chip packaging”, and it has the seventh highest hit rate. Web pages with ranking lower than eighth are also available; typically the user can select additional pages to access additional ranked web pages.

The conventional keyword search illustrated in FIG. 2(c) has its limitations. One limitation is that keyword matching may miss important documents that contain words in different spelling but with equivalent meanings. As illustrated by FIG. 1(c), the program is able to include “packages” and “packaging” when the selected keyword is “package”. Typical keyword matching methods are able to include words with partial match in spelling as the selected keywords, but existing keyword matching methods are not able to include words with different spelling then the selected keywords. This limitation can be removed by searching for not only keywords but also equivalent-phrases. For example, the user can select the “Meaning” (302) options as illustrated in FIG. 2(d). A search program of the present invention can lookup an equivalent-phrase lookup-table similar to the example shown in FIG. 1(e), and find that “chip” is a word that maybe equivalent to “integrated circuit” or “IC”. The lookup-table also can tell that “plastic thin quad flat pack”, “TQFP package”, “BGA package” are types of “chip package”. When the user clicks “Meaning” option (302) as shown in FIG. 2(d), the search engine looks up equivalent-phrase lookup-table(s) to obtain equivalent-phrases of “chip package”, searches for web pages with contents containing keywords “chip package” or equivalent-phrases, and display search results as shown in FIG. 2(d). Typically, the number of web pages (305) with matching keywords or equivalent-phrases is displayed. In the example shown in FIG. 2(d), 4672301 web pages were found to have matching keywords and/or equivalent-phrases. This number is larger than keyword search results shown in FIG. 3(c) because web pages with equivalent-phrases but without matched keywords are added to the list. In this example, the web pages with top seven hit rates are listed as shown in FIG. 2(d). “Web page H” and “web page N” were not listed in FIG. 2(c) because they do not contain both keywords “chip” and “package”. Now they make the list of top seven because they contain equivalent-phrases of the selected keywords. Using conventional keyword searches, these two pages would have been missed. For the example shown in FIG. 2(d), “web page A” is selected because it contains keywords “package potato chips”, “potato chip packaging”, “potato chip packages”, and it is listed on top because of the highest internet hit rate among all web pages with matched keywords or equivalent-phrases of the selected keywords. “Web page B” is listed because it contains keywords “chip-scale packages” and equivalent-phrases “IC packages”, “Integrated circuit packaging”, and it has the second highest hit rate. “Web page C” is listed because it contains “chip”, “packaging”, “package” and equivalent-phrases “plastic IC package”, “TQFP package”, and it has the third highest hit rate. “Web page H”, which was missed by keyword match method, is listed because it contains equivalent-phrases “integrated circuit packaging”, “stacked-dice package”, “plastic thin quad flat pack”, and it has the forth highest hit rate. “Web page D” is listed because it contains keywords “ceramic chip packages” and equivalent-phrases “IC packages”, “BGA packages”, and it has the fifth highest hit rate. “Web page N”, which was missed by keyword match method, is listed because it contains equivalent-phrases “integrated circuits packaging”, “stacked-dice package”, “plastic thin quad flat pack”, and it has the sixth highest hit rate. “Web page E” is listed because it contains “packaging”, “multiple-chip packaging” and equivalent-phrase “integrated circuits”, and it has the seventh highest hit rate. Web pages with ranking lower than eighth are also available; the user can select additional pages to access additional ranked web pages.

The “search by meaning” method illustrated in FIG. 2(d) provides better results than the conventional keyword search illustrated in FIG. 2(c). FIGS. 2(e-h) provide examples for further improvements. For conventional search engines, the ranking results do not change after the initial ranking. If the desired web pages do not have high ranking in hit rates, the user may need to page down and check many web pages before finding the right information, or the user needs to start a new search. It is therefore desirable to provide additional capability to assist the users after initial ranking before starting a new search. One effective method is to provide the option to re-rank the selected documents after initial ranking. For example, the user viewed the top seven web pages, and determined that “web page C” is closest to the user's needs among the top seven web pages in FIG. 2(d). The user would like to find more web pages similar to “web page C”. In conventional methods, the user needs to go through more web pages according to the initial ranking results, and the procedure could be time consuming. FIG. 2(e) shows an example that the user select “web page C” and click the “Re-Rank” option (303). Clicking of the Re-Rank option (303) triggers the program to re-rank web pages by similarity levels in meaning using “web page C” as source document to compare with other web pages using tools similar to those illustrated in FIGS. 1(b-e). The updated ranking results are illustrated in FIG. 2(f). For this example, “web page H” is found to be most similar to “web page C” in meaning among available web pages found by previous search; “web page J” is found to be the second most similar to “web page C” in meaning; “web page N” is found to be the third most similar to “web page C” in meaning; “web page E” is found to be the forth most similar to “web page C” in meaning; “web page K” is found to be the fifth most similar to “web page C” in meaning; and “web page B” is found to be the sixth most similar to “web page C” in meaning. Web pages that are not similar to the source document, such as “web page A” in FIG. 2(d), are no longer listed in the top so that the user can find desired information efficiently.

While the preferred embodiments have been illustrated and described herein, other modifications and changes will be evident to those skilled in the art. It is to be understood that there are many other possible modifications and implementations so that the scope of the invention is not limited by the specific embodiments discussed herein. For example, the similarity ranking was displayed to the user by arranging the sequence of the reference list in the above examples. The similarity ranking also can be displayed by numerical ranking parameters, by colors, by symbols, or by other methods. For another example, the web pages are compared with a source document for similarity ranking in the above examples. Similarity in meaning also can be calculated relative to multiple web pages or part(s) of one web page. FIG. 2(g) shows an example when two web pages are selected as the source documents to re-rank by similarity levels in meaning. Starting from the results in FIG. 2(f), the user selects “web page C” and “web page H” as source documents, and clicks the Re-Rank option (303), as illustrated in FIG. 2(g). Clicking of the Re-Rank option (303) triggers the program to re-rank web pages by similarity levels in meaning using “web page C” and “web page H” as source documents to compare with other web pages using methods similar to the tools illustrated in FIGS. 1(b-e). The updated ranking results are illustrated in FIG. 2(h). For this example, “web page N” is found to be most similar to “web page C” and “web page H” in meaning, among available web pages found by previous search; “web page J” is found to be the second most similar to “web page C” and “web page H” in meaning; “web page L” is found to be the third most similar to “web page C” and “web page H” in meaning; “web page K” is found to be the forth most similar to “web page C” and “web page H” in meaning; and “web page B” is found to be the fifth most similar to “web page C” and “web page H” in meaning. The user can continue to use the Re-Rank option (303) until he/she find all the needed information.

While the preferred embodiments have been illustrated and described herein, other modifications and changes will be evident to those skilled in the art. For example, the user needs to select the source document and click the Re-Rank option to start re-ranking in the above example. Another approach is to monitor the activities of a user and update the ranking automatically. The re-ranking procedures also can be partially automatic and partially manual. It is to be understood that there are many other possible modifications and implementations so that the scope of the invention is not limited by the specific embodiments discussed herein. The above examples illustrate applications of the present invention for web pages. Similar tools are also applicable for other types of written documents such as electrical mails or book references. In the above example, ranking by similarity level in meaning is used to rearrange the ranking order of web pages, while other ranking methods, such as ranking by word-by-word comparison, ranking by keyword matches, and so on, are also applicable for re-ranking. The re-ranking procedure can be executed among a subset (e.g. the web pages with top 100 hit rates) of the written documents found by a search. It is desirable to transfer the contents of web pages to a local data storage device to have better efficiency in re-ranking.

FIGS. 3(a-g) show exemplary application of ranking by similarity level in meaning for patent references. When a user starts the software program in this example, a selection box (101) pops up, and the selection box provides three choices (101) as illustrated in FIG. 3(a); a “Source” option allows the user to select a source document, a “Reference” option allows the user to search and/or select a set of references, and a “Vote” option allows the users to vote in order to influence the popularity ranking of references. For example, the user can click the “Source” option, and select a patent application with Ser. No. 12,165,658 as the source document (103), as shown in FIG. 3(b). For clarity, in this example only the section headers (Title, Abstract, Summary, Figures, Claims, and Text) of the source document are shown while the actual program may display complete text and figures. Selection boxes (104) in front of each section header allow the user to select the contents of the source document (103) represented by those section headers. For example, a user can click the selection box (104) in front of the “Text” header and select paragraph 11 to 15 and column 1 line 4 to column 2 line 6 of the text of the source document, as illustrated in FIG. 3(c).

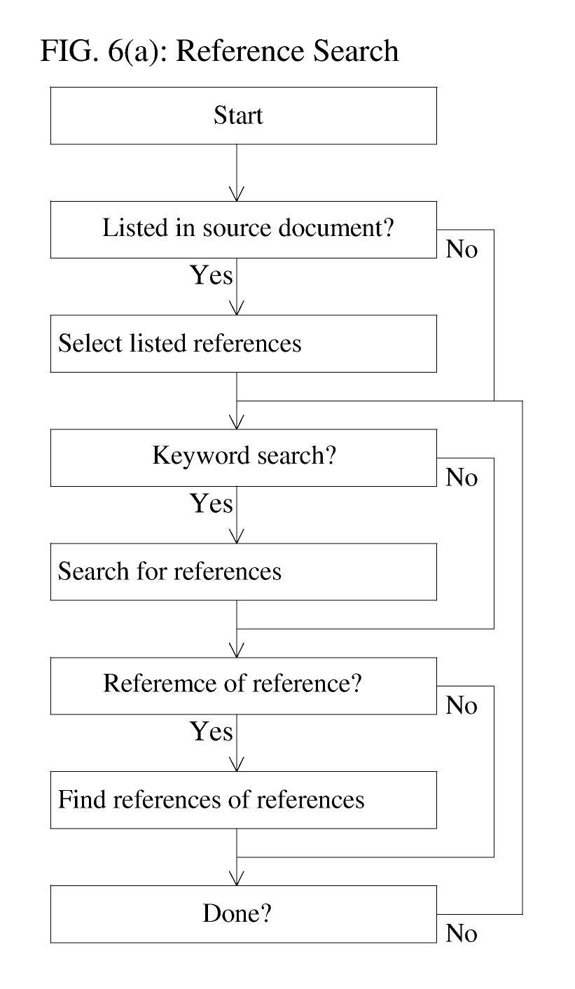

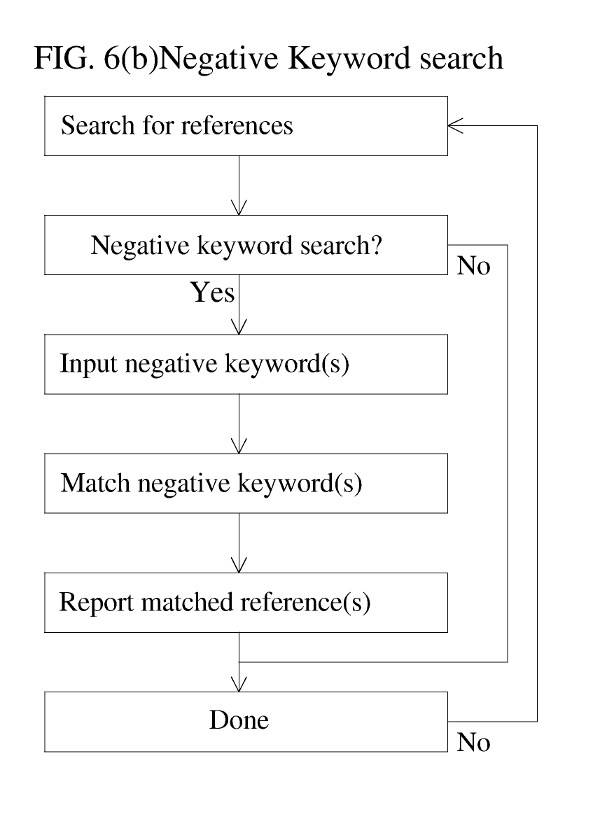

In this example, the user can click the “Reference” option to select a set of potentially useful references, as illustrated by FIG. 3(c). There are many ways to search for references. FIG. 6(a) shows an exemplary flow chart for the reference searching methods. The source document may provide a list of references. Typically, the listed references of the source document are included in the list of potentially useful references. The user can search for more references by keyword searches similar to the patent search utility program in the US Patent Office web site. To expand the list, a software program can lookup references listed in the references that are already included. The user may repeat the above procedures until a thorough search is done, as illustrated by the flow chart in FIG. 6(a).

Typically, the procedures in FIG. 6(a) can find a large number of references while many of them may not be useful. One method to screen out references that are unlikely to be useful is “negative keyword search”. In a keyword search, a document with matched keyword(s) is considered more likely to be useful. In a negative keyword search, a document with matched negative keyword(s) is considered less likely to be useful. Sometimes, negative keyword search can be exclusive; documents with matched negative keyword(s) can be removed from the list of potential useful documents. For example, a user may use keywords “chip package” to search for documents related to packaging technologies of integrated circuit chips, while the search results may include a lot of documents related to methods in packaging potato chips. In this case, the user can use negative keywords “potato chip” in a negative keyword search to screen out documents related to potato chips. FIG. 6(b) shows an exemplary flow chart of negative keyword search. A user starts by normal search methods such as the exemplary procedure illustrated by FIG. 6(a). After or during the normal search, the user can input negative keyword(s). When negative keyword(s) are found in a document, the software program would report the finding to provide warning, to reduce priority, or to remove the document from selected list. The procedures may need multiple iterations to obtain final search results.

The negative keyword search helps to reduce the number of useless references in the selected list. It is desirable to provide further measures to distinguish references that are more likely to be useful while pointing out references that are unlikely to be useful. For the examples shown in FIGS. 3(c-g), a set of 7 potentially useful references (105) are shown in this example while practical cases may need to rank a large number of references.

After a set of references are collected, a ranking box (102) is opened as shown in FIG. 3(c). When the user clicks the ranking box (102), ranking options (107) appear. In FIGS. 3(c-g), two ranking options are provided: ranking by similarity level in meaning (Similarity) and ranking by popularity (Popularity). If the user clicks the “Similarity” ranking option, reference section headers (108) appear to allow the user to determine the priority in various sections of references to be analyzed for similarity ranking as shown in FIG. 3(d). In FIGS. 3(a-g), a “/” sign in the option select box means the item is selected, while an “x” sign in the option select box means the item is selected with higher priority. For example, assuming the user wants to compare paragraph 11 to 15 and column 1 line 4 to column 2 line 6 of the text of the source document to all contents of the references with higher priority on abstract and claims, and highest priority on claims and title of the selected references, the user should put a “x” sign in the “Text” option of the source document, a “/” sign on the “All” option of the reference section, a “/” sign on “Abstract” of the reference section option, and “x” signs on the “Title” and “Claim” of the reference section options (108), as shown in FIG. 3(d). Based on the selected options, a program collect keywords and equivalent-phrases from the contents of the source documents, calculates the similarity level in meaning of each reference, and then rearranges the order of references as shown in FIG. 3(d). In this example, reference [3] has the highest similarity level in meaning between the selected reference sections and the selected texts of the source document. Similarly, reference [2] has the second highest similarity, reference [6] has the third highest similarity, reference [4] has the forth highest similarity, reference [5] has the fifth highest similarity, reference [1] has the sixth highest similarity, and reference [7] has the lowest similarity. Such similarity rankings can assist users to determine which references are more likely to be useful. It is also desirable to use software to highlight similar content (such as matched words, equivalent-phrases, or sections with high degree of similarity in meanings) in the references so that the users can know which parts of a reference are more likely to be useful.

For another example, in additional to the selected text, the user wants to include “Title” and “Summary” of the source document to be compared with all contents of the references, with higher priority on summary and claims of the selected references and with highest priority on the figures and title of the selected references. To do so, the user puts an “x” sign in the “Text”, “Title”, and “Summary” options of the source document, a “/” sign on the “All”, “Summary” and “Claims” of reference section options (108), and “x” signs on the “Title” and “Figures” of the reference section options (108), as shown in FIG. 3(e). Based on the selected options, a program collect keywords and equivalent-phrases from the selected sections of the source document, calculates the similarity levels of each reference, and then rearranges the order of references as shown in FIG. 3(e). In FIGS. 3(a-g) ranking results are represented by the sequences of the references. In this example, reference [2] has the highest similarity level in meaning to the selected text of the source document, reference [6] has the second highest similarity, reference [3] has the third highest similarity, reference [5] has the forth highest similarity, reference [4] has the fifth highest similarity, reference [7] has the sixth highest similarity, and reference [1] has the lowest similarity. The similarity ranking assists the user to determine which references are more likely to be useful. Software programs also can highlight related contents of references when the references are viewed.

While the preferred embodiments have been illustrated and described herein, other modifications and changes will be evident to those skilled in the art. For example, the similarity ranking was displayed to the user by arranging the sequence of the reference list in the above example. The similarity ranking also can be displayed by numerical ranking parameters, by colors, by symbols, or by other methods. In the above example the references are compared with a source document for similarity ranking. Sometimes similarity level in meaning can be calculated relative to a list of keywords without a source document. The re-ranking options shown in FIGS. 2(a-h) are certainly applicable for updating the ranking of patent references. It is to be understood that there are many other possible modifications and implementations so that the scope of the invention is not limited by the specific embodiments discussed herein.

Besides similarity ranking, other ranking methods are also applicable to rank references. For example, the user can click the “Popularity” option in the ranking option (107), and the popularity ranking options (109) would appear, as shown in FIG. 3(f). In this example, the user has the options to rank popularity according to how often a reference is referred to (Referred), how many copies of a reference has been sold (Sale), how many users voted for the references (Voted), or all of the above (All), as illustrate in FIG. 3(f). Assuming the user selects the “Referred” option among the “Popularity” ranking options, a program ranks the selected references according to how often they are listed as references, and then rearranges the order of references as shown in FIG. 3(f). In this example, reference [6] is the most popular, reference [7] is the second most popular, reference [3] is the third popular, reference [5] is the forth popular, reference [4] is the fifth popular, reference [1] is the sixth popular, and reference [7] is the least popular references.

It is often desirable to combine more than one ranking methods. For example, the user can click both the “Similarity” and the “Popularity” ranking options (107) as shown in FIG. 3(g). After selecting ranking options in ways similar to previous examples, a software program calculates the ranking of references by combining both similarity and popularity criteria. For the example shown in FIG. 3(g), reference [6] has the highest ranking, reference [7] has the second highest ranking, reference [2] has the third highest ranking, reference [3] has the forth highest ranking, reference [5] has the fifth highest ranking, reference [4] has the sixth highest ranking, and reference [1] has the lowest ranking among the selected references.

While the preferred embodiments have been illustrated and described herein, other modifications and changes will be evident to those skilled in the art. Besides the “Referred” option, the use can select “Sale”, “Voted”, “All”, or a combination of different options with various combinations of priorities for popularity ranking. The ranking results were displayed to the user by arranging the sequence of the reference list in the above example while the ranking results also can be displayed by a ranking number, by colors, by symbols, or other methods. It is to be understood that there are many other possible modifications and implementations so that the scope of the invention is not limited by the specific embodiments discussed herein.

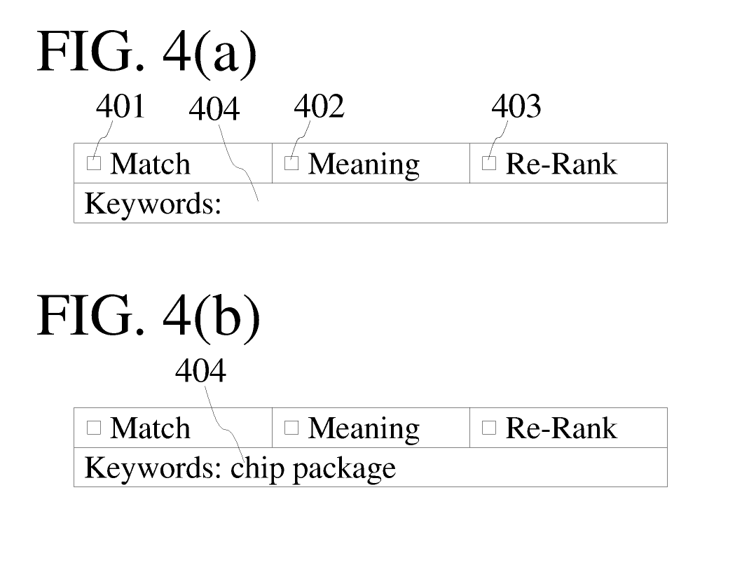

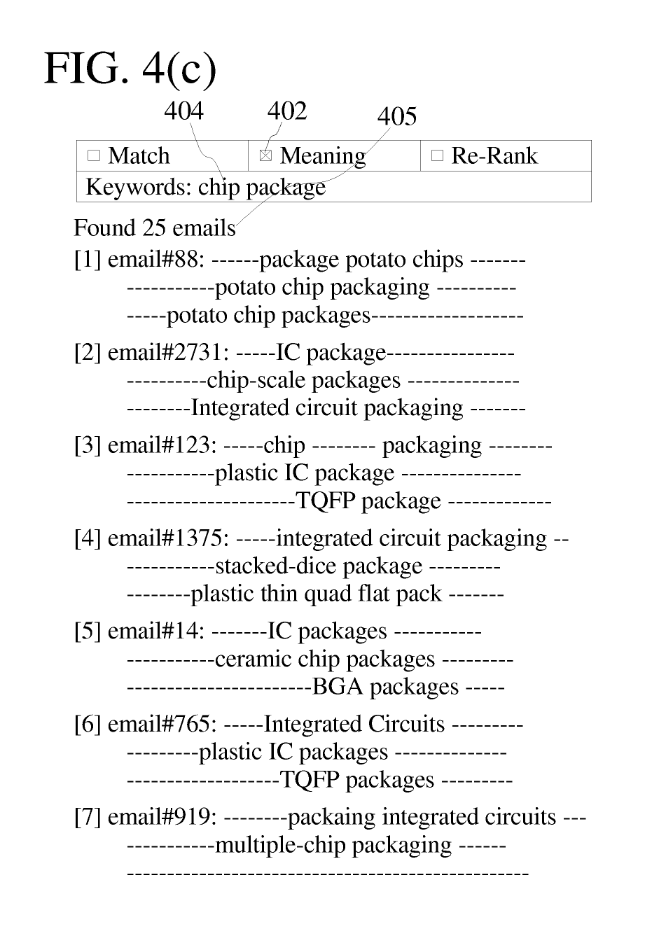

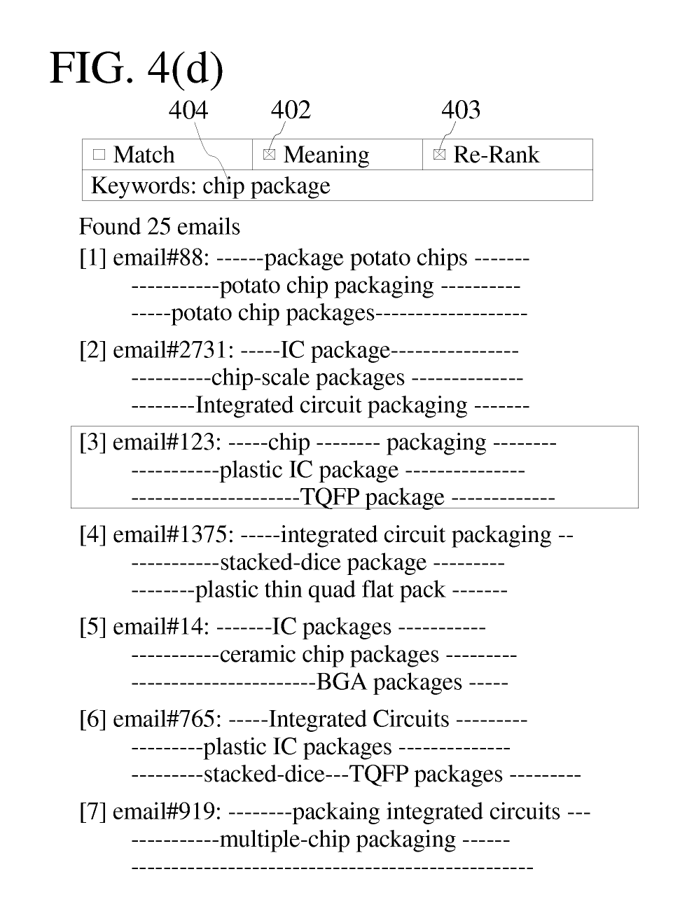

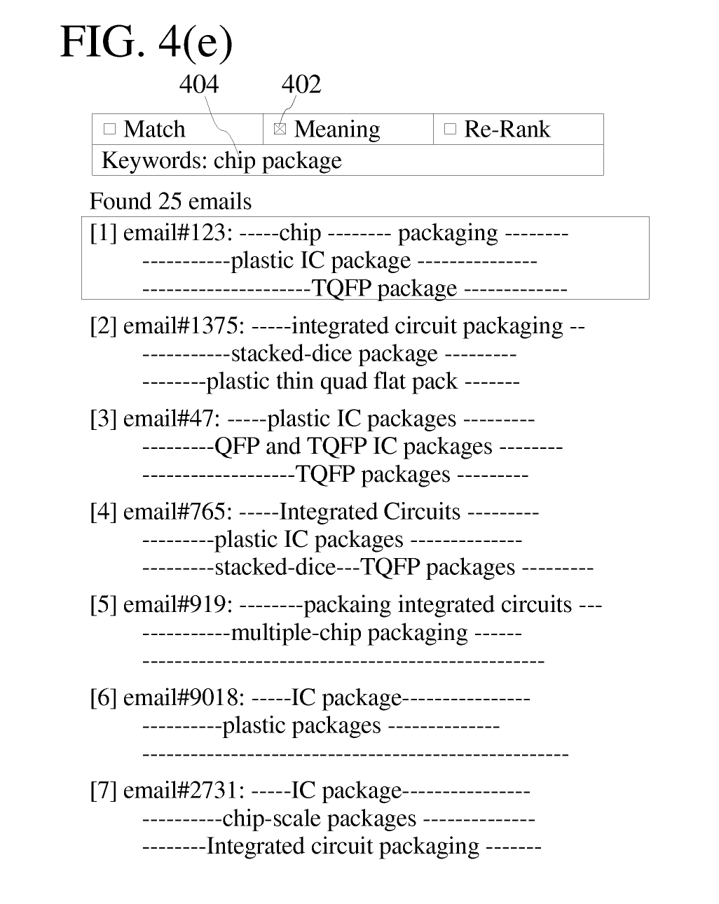

Before the age of electrical mails, a person may save a few precious letters in the drawer. Finding and reviewing an old mail was a simple task. Now we can save thousands or even millions of electrical mails in free storage systems provided by internet service companies. Finding an old electrical mail among numerous stored emails can be very difficult. FIGS. 4(a-e) show exemplary methods that help to find electrical mails. FIG. 4(a) shows selection boxes displayed on screen when a user starts the program in this example. The selection boxes provide three options (401-403): a “Match” option (401) that allows the user to search stored electrical mails using conventional keyword match methods, a “Meaning” option (402) that allows the user to search for electrical mails with matching keywords as well as matching equivalent-phrases of keywords, and a “Re-Rank” option (403) that allows the users to update ranking results after initial ranking without starting a new search. Below the three options (401-403), a keyword input box (404) that allows the user to type in keywords is also displayed. For this example, the user types in keywords “chip package” in the keyword input box (404) as shown in FIG. 4(b), and selects the “Meaning” (402) options as illustrated in FIG. 4(c). A search program of the present invention can lookup an equivalent-phrase lookup-table similar to the example shown in FIG. 1(e), and find that “chip” is a word that maybe equivalent to “integrated circuit” or “IC”. The lookup-table also can tell that “plastic thin quad flat pack”, “TQFP package”, “BGA package” are types of “chip package”. When the user clicks “Meaning” option (402) as shown in FIG. 4(c), the search program looks up the equivalent-phrase lookup-table(s) to obtain equivalent-phrases of “chip package”, searches for stored electrical mails with contents containing keywords “chip package” or their equivalent-phrases, and display search results as shown in FIG. 4(c). Typically, the number of electrical mails (405) with matching equivalent-phrases is displayed. In the example shown in FIG. 4(c), 25 electrical mails were found to have matching keywords and/or equivalent-phrases. In this example, the electrical mails with latest dates are listed. For the example shown in FIG. 4(c), email #88 is selected because it contains keywords “package potato chips”, “potato chip packaging”, “potato chip packages”, and it is listed on top because of latest date among the electrical mails with matched keywords or equivalent-phrases of the selected keywords. Email #2731 is listed because it contains keywords “chip-scale packages” and equivalent-phrases “IC packages”, “Integrated circuit packaging”, and it has the second latest date. Email #123 is listed because it contains “chip”, “packaging”, “package” and equivalent-phrases “plastic IC package”, “TQFP package”, and it has the third latest date. Email #1375 is listed because it contains equivalent-phrases “integrated circuit packaging”, “stacked-dice package”, “plastic thin quad flat pack”, and it has the forth latest date. Email #14 is listed because it contains keywords “ceramic chip packages” and equivalent-phrases “IC packages”, “BGA packages”, and it has the fifth latest date. Email #765 is listed because it contains equivalent-phrases “integrated circuits packaging”, “stacked-dice package”, “plastic thin quad flat pack”, and it has the sixth latest date. Email #919 is listed because it contains “packaging”, “multiple-chip packaging” and equivalent-phrase “integrated circuits”, and it has the seventh latest date. Electrical mails with ranking lower than eighth are also available; the user can select additional pages to access additional ranked electrical mails.

The “search by meaning” method illustrated in FIG. 4(c) provides better results than the conventional keyword searches. For conventional electrical mail searches, the ranking results do not change after the initial ranking. It is desirable to provide the option to re-rank the selected electrical mails after initial ranking before starting a new search. For example, the user viewed the top seven electrical mails, and determined that email #123 is closest to his/her needs among the top seven electrical mails in FIG. 4(c). Typically, the user would like to find more electrical mails similar to email #123. In conventional methods, the user needs to go through more electrical mails according to the initial ranking results, and the procedure could be time consuming. FIG. 4(d) shows an example that the user selects email #123 and clicks the “Re-Rank” option (403). Clicking of the Re-Rank option (403) triggers the program to re-rank electrical mails by similarity levels in meaning using email #123 as source document to compare with other electrical mails using tools similar to those illustrated in FIGS. 1(b-e). The updated ranking results are illustrated in FIG. 4(e). For this example, email #1375 is found to be most similar to email #123 in meaning among available electrical mails found by previous search; email #47 is found to be the second most similar to email #123 in meaning; email #765 is found to be the third most similar to email #123 in meaning; email #919 is found to be the forth most similar to email #123 in meaning; email #9018 is found to be the fifth most similar to email #123 in meaning; and email #2731 is found to be the sixth most similar to email #123 in meaning.

While the preferred embodiments have been illustrated and described herein, other modifications and changes will be evident to those skilled in the art. It is to be understood that there are many other possible modifications and implementations so that the scope of the invention is not limited by the specific embodiments discussed herein.

The Bible is a classic example of a “renowned book”. Thousands of versions of translations have been published for The Bible. Most translations agree with one another on most parts of The Bible. However, there are controversial verses that different versions provide different translations. Not one of the versions is considered as the perfect translation for all parts of The Bible; different versions provide better translations for different parts of The Bible. It is therefore desirable to provide tools that can help Bible readers to recognize controversial verses. It is also desirable to develop tools for helping readers to choose from a large number of bible study materials for better understanding. In the meantime, ranking supporting documents of The Bible can be highly controversial. It is highly desirable to provide software tools that are as objective as possible while allowing the readers to make final decisions. It is also highly desirable to avoid direct interpretation of the Bible without supports from reliable sources. It is desirable to limit ranking tools on ranking existing translations or commentaries objectively. The tools are designed to simplify searching from piles of supporting documents while minimizing subjective influences to the readers. The program should respect the views of readers instead of the revealing views of programmers.

FIGS. 5(a-k) shows simplified examples of bible study tools that utilize ranking methods to help readers to select from numerous supporting documents. After a user logs in, this exemplary software program displays selection boxes (201) shown in FIG. 5(a). If the user clicks the “Language” box, a list of translation language options (202) would pop up for the user to select, as shown in FIG. 5(b). Four languages are available in this example while the actual program may provide more language options. The user also can select the book(s), chapter(s), and verse(s) of The Bible to be studied. For the example shown in FIG. 5(b), English is selected as the translation language, and chapter 13 verses 12-14 of the book of Hosea are selected. If the user clicks the “Translation” box, a list of available translations (204) would pop out for the user to select, as shown in FIG. 5(c). Seven versions (King James, New International version, New American Standard, English Standard Version, New King James Version, American Standard Version, and New Century Version) are available in this example. Actual programs typically provide more versions of translations. It is desirable for the user to have the flexibility to add or to remove translations from the list. When the user is selecting translations, ranking options (203) pop up to assist the user. For the example shown in FIG. 5(c), ranking by popularity, ranking by expert opinion, and ranking by controversy are available for the user, while actual program may provide different options. The user also can choose not to use any ranking tools. For example, the user can click and select King James, and the translation of verses 12-14 of Hosea Chapter 13 by King James are displayed in a box (210) as shown in FIG. 5(d).

The user may use ranking tools to select translations. For example, the user can click the “Popularity” ranking option, and use one of the popularity ranking methods discussed in previous sections to rank the available translations. In this example, the software program would re-arrange the sequence of available translation versions (204) according to popularity ranking, as shown in FIG. 5(e). In this example, New International Version is the most popular translation for the selected verses. King James is the second most popular, New American Standard is the third popular, New King James Version is the third popular, American Standard Version is the forth popular, New Century Version is the fifth popular, and English Standard Version is the least popular, as shown in FIG. 5(e). The user can re-select the translation according to the ranking information. For example, this time the user clicks and selects the New International Version (NIV), and the NIV translations of the selected verses (210) are displayed as shown in FIG. 5(f).

Comparing the King James translation in FIG. 5(d) and the NIV translation in FIG. 5(f), the words are different while the meanings are the same. It is true for most parts of The Bible that different translations provide the same interpretations in meaning. Therefore, for most parts of The Bible, choosing which version makes little difference in understanding. However, there are controversial parts in The Bible where different translations may provide different interpretations in meaning. It is desirable to provide indicators so that the users can know which parts of the Bible have different translations in meanings. For example, the user can click the “Controversy” option (206) asking the program to provide controversy indicators (212, 213, 214), as shown in FIG. 5(g). Clicking the controversy option (206) starts a program that executes comparison by similarity levels in meanings on available translations for the selected verses. If the meanings for all the translations for one of verse are the same, the controversy level for that verse is low. If there are significant differences in meaning among different translations of one verse, the controversy level for that verse is high. In this example, the controversy level of each verse is indicated by underlining the verse numbers. For example, verse 12 has low controversy level, so that its verse number is not underlined (212); verse 13 is somewhat controversial, so its verse number is underlined with one line (213); and verse 14 is controversial, so its verse number is underlined with double lines (214), as shown in FIG. 5(g). Providing controversy indicators (212-214) is one example of the application of ranking by similarity level in meaning. Besides differences in meaning among available translations, the controversy indicators also can indicate other types of controversies. For example, a verse that people tend to have questions can be assigned with higher controversy level than a verse that almost no one asked any questions. For another example, a verse that is quoted by other parts of The Bible can be assigned with higher controversy level than a verse that is not quoted by other parts of The Bible. The controversy level indicators can provide combinations of many factors. It is very important to apply objective measures for determination of controversy levels.

For a controversial verse, it is desirable to compare different translations on the same screen. For example, the user can click to select verse 14, a circle (215) appears on the selected verse number to indicate that the verse has been selected. In the mean time, a list of other available translations (222) and ranking methods (223) pops up, as shown in FIG. 5(g). In this example, the previous 6 versions (222) of translations are available. Ranking by popularity, ranking by similarity, ranking by difference, and ranking by expert opinion are available ranking tools (223). The actual program may provide different ranking options. The translations for Hosea 13:14 by the 7 versions in this example are provided in the following sections.

In King James, the translation for Hosea Chapter 13 verse 14 is:
“I will ransom them from the power of the grave;
I will redeem them from death:
O death, I will be thy plagues;
O grave, I will be thy destruction:
Repentance shall be hid from mine eyes.”

In New King James, the translation for Hosea Chapter 13 verse 14 is:
“I will ransom them from the power of the grave;
I will redeem them from death.
O Death, I will be your plagues!
O Grave, I will be your destruction!
Pity is hidden from my eyes.”

In New International Version, the translation for Hosea Chapter 13 verse 14 is:
“I will ransom them from the power of the grave;
I will redeem them from death.
Where, O death, are your plagues?
Where, O grave, is your destruction?
I will have no compassion.”

In American Standard Version, the translation for Hosea Chapter 13 verse 14 is:
“I will ransom them from the power of Sheol;
I will redeem them from death:
O death, where are thy plagues?
O Sheol, where is thy destruction?
Repentance shall be hid from mine eyes.”

In New American Standard, the translation for Hosea Chapter 13 verse 14 is:
“Shall I ransom them from the power of Sheol?
Shall I redeem them from death?
O Death, where are your thorns?
O Sheol, where is your sting?
Compassion will be hidden from my sight.”

In English Standard Version, the translation for Hosea Chapter 13 verse 14 is:
“Shall I ransom them from the power of Sheol?
Shall I redeem them from Death?
O Death, where are your plagues?
O Sheol, where is your sting?
Compassion is hidden from my eyes.”

In New Century Version, the translation for Hosea Chapter 13 verse 14 is:
“Will I save them from the place of the dead?
Will I rescue them from death?
Where is your sickness, death?
Where is your pain, place of death?
I will show them no mercy.”

For simplicity, only 7 versions are shown in this example. Reading above translations, we can see that conventional word-by-word comparisons or keyword comparisons are unlikely to be helpful in analyzing Bible translations. For example, those tools would not be able to know that Sheol and grave are equivalent in meaning, sight and eyes can have similar meanings, and that a sentence ends in question mark can have different meanings for a sentence with similar words but ends in period. In the mean time, text analysis by meanings with the help of the tools similar to those in FIGS. 1(b-e) would be able to understand those points and provide helpful analysis.

For example, a reader may want to read the translation that is the most different from NIV translation for Hosea 13:14. FIG. 5(h) shows an example on how to achieve the purpose using ranking by similarity level in meaning. In this example, the user clicks the “Similarity” option in the Ranking options (223), and an option box (226) for ranking by similarity pops up, as shown in FIG. 5(h). This program provides ranking by similarity in three optional methods: meaning comparisons (Meaning), word by word comparisons (Words), or keyword matching (Keyword). As discussed previously, conventional word-by-word or keyword comparisons would not be useful to study Hosea 13:14 or most parts of The Bible. Therefore, the suggested method is to select ranking by similarity level in meanings. The program ranks available translations by similarity level in meaning, and re-arranges the sequence of the available translations as shown in FIG. 5(h). In this example, it determines that King James translation of Hosea 13:14 is the most similar translation in meanings to NIV, New King James Version is the second most similar, American Standard Version is the third most similar, New American Standard is forth most similar, English Standard Version is the fifth most similar, and New Century Version is the least similar translation, as shown in FIG. 5(h). Since the purpose of the user is to read the translation that is the most different from NIV, the user clicks to select New Century Version, and the translations of New Century Version is shown in a box (220) for side-by-side comparison as shown in FIG. 5(h).

To compare different versions of translations, typically the user would like to ignore translations that are in the same meanings and view translations that are different in meanings. Ranking by difference is a ranking tool designed for such application. As discussed in previous sections, ranking by difference is a special case of ranking by similarity levels. However, a software program may choose to provide selection boxes for both of them.

FIG. 5(i) shows an example for the application of ranking by difference. In this example, the user click and select the “Difference” option in the ranking option (223) to activate the ranking by difference functions. For the example in FIG. 5(i), after the ranking by difference option is selected, the software program determines that only three versions (English Standard Version, New Century Version, and New American Standard) provide translations with different meanings relative to the NIV translation (210) so that only those three versions are displayed in the selection list of other translations (222). The user may want to have additional information to select one of those three options. In this example, the user clicks and selects ranking by popularity, and an option box (224) for popularity ranking pops up, allowing the user to define popularity by number of votes and/or by number of selections and/or by number of quotations and/or by number of sales and/or by all of the above, as shown in FIG. 5(i). In this example, the user selects ranking by popularity according to number of votes in combination with ranking by differences. The results showed that English Standard Version has the highest ranking, New Century Version has the second highest ranking, and New American Standard has the third highest ranking. With the information, the user clicks English Standard Version, and the selected translation (220) is displayed on screen as shown in FIG. 5(i). The user also has the option not to follow the ranking results.

While the preferred embodiments have been illustrated and described herein, other modifications and changes will be evident to those skilled in the art. In the above example, the second translation was displayed at the bottom of the first translation, while we can provide the option to display them side-by-side. It is also possible to display the third and more translations. The ranking methods shown in the above examples are not only applicable to translations but also applicable to commentaries, references, or other supporting documents. Similar methods are certainly applicable to books other than The Bible. It is to be understood that there are many other possible modifications and implementations so that the scope of the invention is not limited by the specific embodiments discussed herein.

FIG. 5(j) shows another example when the user selects ranking by difference in combination with ranking by expert opinion. Upon selection of the “Expert” option (223), a list of experts (225) pops up. In this example, the user selects “Editor” as the expert to rank the translations that have different meanings. The software program looks up the opinion of the editor to rank in combination with ranking by difference. In this example, New American Standard has the highest ranking, English Standard Version has the second highest ranking, and New Century Version has the third highest ranking. Assisted by the information, the user clicks New American Standard, and the translation of verse 14 in New American Standard is displayed on screen as shown in FIG. 5(j). The user has the option not to follow the ranking results. In comparison, the translation of New American Standard is nearly identical to that of English Standard Version except the last word. It is desirable for the user to have the option to select combined opinions of different experts. FIG. 5(k) shows an example when the user selected “All” and “John” in the pop up box (225). The software program looks up the opinion of all the available experts with higher priority on John's opinion, in combination with ranking by difference, the ranking results showed that English Standard Version has the highest ranking, New Century Version has the second highest ranking, and New American Standard has the third highest ranking. Assisted by the information, the user clicks English Standard Version, and the translation of verse 14 in English Standard Version is displayed for comparison, as shown in FIG. 5(k).

While the preferred embodiments have been illustrated and described herein, other modifications and changes will be evident to those skilled in the art. Using software programs to calculate ranking parameters is fast and objective. However, ranking does not always have to be executed only by software programs. Sometimes other methods, such as human opinions, can be used to assist ranking methods. In the above examples, users have the option to choose according to their own judgment. The user can select the second or the third options instead of the highest ranking option. The user also can ignore the ranking results. Sometimes, it is beneficial to select the lowest ranking options as shown by the example in FIG. 5(h). It is to be understood that there are many other possible modifications and implementations so that the scope of the invention is not limited by the specific embodiments discussed herein. Existing bible study software typically can execute keyword searches to find all the verses in bible that contain the same keywords. Using equivalent-phrase lookup-table(s) to find all the verses that contain words in similar meanings provides helpful methods for bible studies. English language is used in the above examples, while the present invention is applicable for other languages, or mixture of multiple languages. The contents and source texts of an equivalent-phrase lookup-table also can include different languages or mixture of different languages.

The present invention is related to methods or tools for searching, selecting, or ranking numerous written documents stored in data storage system(s), especially when the number of related written documents is very large—hundreds, thousands, millions, or more. Typically, software program(s) are provided to select a set of written documents from a plurality of written documents stored in data storage system(s) using search procedures; the number of selected written documents is typically more than 4 to be worth while for ranking. Typically, keyword(s) and/or source document(s) are received from input(s) by the users. Unlike conventional keyword matching methods, the preferred embodiments of the present invention provide equivalent-phrase lookup-table(s) so that software program(s) can look up equivalent-phrases related to the selected keyword(s) and/or source document(s). Ranking program(s) calculate a similarity level in meaning for each written document in the set of selected written documents by comparing the contents of each written document with said equivalent-phrases related to selected keyword(s) and/or source document(s), and using the similarity level in meaning calculated for each of said selected written documents as part of or all of the criteria to determine the ranking order of the selected set of written documents. The ranking results are typically displayed on a display devices.

Such preferred embodiments of the present invention can support various applications. For examples, ranking by similarity levels in meaning are applicable for ranking web pages, electrical mails, book references, potentially useful references found by patent search(es), patent publications, or bible translations. It is typically desirable to combine ranking by similarity level in meaning with other ranking methods such as ranking by popularity, ranking by internet hit rates, ranking by expert opinions, and so on, as illustrated by the above examples.

An equivalent-phrase lookup-table used by the preferred embodiments of the present invention can be stored in networked data storage device(s) so that many users can share the same lookup-table. However, it maybe preferable to have local equivalent-phrase lookup-table(s) customized for individual users. It maybe desirable to allow a user to edit the contents of equivalent-phrase lookup-tables to customize for individual user. Typically, the ranking results are displayed on computers. The ranking results also can be displayed on portable electronic devices such as portable computers, electronic books, or cellular phones. It is typically desirable to have different equivalent-phrase lookup-table(s) for different fields of applications. For example, an equivalent-phrase lookup-table used for bible studies can be different from equivalent-phrase lookup-table for integrated circuit technologies.

Preferred embodiments of the present invention also improves ranking of web pages by rearranging ranking order by monitoring operations executed by the user after initial ranking without starting a new search. Preferably, the rearranged ranking order after initial ranking involves ranking by similarity level in meaning, but other ranking methods are also applicable. The rearranged ranking order after initial ranking can be executed manually or automatically. Preferred embodiments of the present invention also can improve web page searches by providing equivalent-phrase lookup-table(s) to allow searching for not only keyword(s) but also equivalent phrases of selected keyword(s).

While specific embodiments of the invention have been illustrated and described herein, it is realized that other modifications and changes will occur to those skilled in the art. It is therefore to be understood that the appended claims are intended to cover all modifications and changes as fall within the true spirit and scope of the invention.

What is claimed is:

1. A method for ranking written documents, comprising the steps of:
Storing a plurality of written documents in data storage system(s);
Providing equivalent-phrase lookup-table(s);
Receiving user input(s) for selecting keyword(s) and/or source document(s);
Selecting a set of written documents from said plurality of written documents stored in data storage system(s);
Executing software program(s) to look up said equivalent-phrase lookup-table(s) for equivalent-phrases related to said keyword(s) and/or source document(s);
Executing ranking program(s) to calculate a similarity level in meaning for each of said set of written documents by comparing contents of the set of written documents with said equivalent-phrases and/or keyword(s) and/or source document(s), and using the similarity level in meaning for each of the written documents to determine a ranking order between the selected written documents; and
Displaying the ranking order on a display device.

2. The method in claim 1 wherein the steps of determining the ranking order of a set of written documents comprises a step of determining the ranking order of a plurality of web pages.

3. The method in claim 1 wherein the steps of determining the ranking order of a set of written documents comprises a step of determining the ranking order of a plurality of electrical mails.

4. The method in claim 1 wherein the steps of determining the ranking order of a set of written documents comprises a step of determining the ranking order of a plurality of book references.

5. The method in claim 1 wherein the steps of determining the ranking order of a set of written documents comprises a step of determining the ranking order of a plurality of potentially useful references found by patent search(es).

6. The method in claim 1 wherein the steps of determining the ranking order of a set of written documents comprises a step of determining the ranking order of a plurality of patent publications.

7. The method in claim 1 wherein the steps of determining the ranking order of a set of written documents comprises a step of determining the ranking order of a plurality of bible translations.

8. The method in claim 1 wherein the steps of determining the ranking order of a set of written documents comprises a step of taking into account of the popularity of the set of documents in determining the ranking order of the set of written documents.

9. The method in claim 8 wherein the steps of determining the ranking order of a set of written documents comprises a step of taking into account of the internet hit rates of the set of documents in determining the ranking order of the set of written documents.

10. The method in claim 1 wherein the steps of determining the ranking order of a set of written documents comprises a step of taking into account of the punctuations in the written documents.

11. The method in claim 1 further comprises a step of displaying the ranking order on a portable electronic device.

12. The method in claim 11 further comprises a step of displaying the ranking order on a portable computer.

13. The method in claim 11 further comprises a step of displaying the ranking order on an electronic book.

14. The method in claim 11 further comprises a step of displaying the ranking order on a cellular phone.

15. The method in claim 1 further comprises a step of displaying the ranking order on a computer.

16. A method for ranking a plurality of web pages, comprising the steps of:
Storing the web pages in data storage system(s);
Executing software program(s) to search and select a set of web pages from said web pages stored in data storage system(s), and proving an initial ranking order for said set of web pages;
Monitoring operations executed by user(s) to rearrange the ranking order of the set of web pages without starting a new search;
Displaying the rearranged ranking order on a display device.

17. The method in claim 16 wherein the step of rearranging the ranking order of the set of web pages further comprises a step of executing ranking program(s) to calculate a similarity level in meaning for each of said web pages as part of or all of the criteria for rearranging the ranking order of said web pages.

18. The method in claim 16 wherein the step of rearranging the ranking order of the set of web pages further comprises a step of automatically rearranging the ranking order of said web pages.

19. A method for searching web pages, comprising the steps of:
Storing a plurality of web pages in data storage system(s);
Providing equivalent-phrase lookup-table(s);
Receiving user input(s) for selecting keyword(s);
Looking up said equivalent-phrase lookup-table(s) for finding equivalent-phrases related to said selected keyword(s);
Executing a search program for searching the web pages containing the equivalent-phrases of said selected keyword(s).

20. The method in claim 19 further comprising a step of rearranging a ranking order of the web pages based on user inputs after initial ranking without starting a new search.
